(19) United States
(12) Patent Application Publication
(10) Pub. No.: US 2024/0220901 A1
(43) Pub. Date: Jul. 4, 2024

(54) A METHOD OF AND SYSTEM FOR MONITORING A BUILDING

(71) Applicant: Information Grid Ltd, Chelmsford (GB)

(72) Inventors: William Cowell De Gruchy, Chelmsford (GB); Aidan Russell, Chelmsford (GB); Samuel Lioyd, Chelmsford (GB); khiloni Westpely, Chelmsford (GB); Ben Wheeler, Chelmsford (GB); Robrn Hornak, Chelmsford (GB); Simon Shillaker, Chelmsford (GB); Bemhard Wenzel, Chelmsford (GB); Amy Lai, Chelmsford (GB)

(21) Appl. No.: 18/554,642

(22) PCT Filed: Apr. 11, 2022
(86) PCT No.: PCT/GB2022/050902

§ 371 Date: Oct. 10, 2023

(30) Foreign Application Priority Data
Apr. 12, 2021 (GB) 2105145.4
Apr. 12, 2021 (GB) 2105179.2
Jun. 8, 2021 (GB) 2108191.4

(51) Int. Cl. G06Q 10/0635; G06Q 50/08

(52) U.S. Cl. CPC G06Q 10/0635; G06Q 50/08

(57) ABSTRACT

A method of monitoring a building comprises the steps of: (a) using a network of sensors in the building to measure multiple different environmental parameters; and (b) automatically processing the environmental performance parameters, using a scoring algorithm running on a processor, to generate an overall healthy building score. The environmental performance parameters include values for one or more of the following: ventilation; air quality; thermal health; moisture; dust; safety; water quality; noise; lighting; legionella compliance; desk occupancy.

### BACKGROUND OF THE INVENTION

### 1. Field of the Invention

This invention relates to a method of, and system for, monitoring a building; it includes a method of generating a score indicative of how healthy a building. It covers also some specific building monitoring techniques that can be used when generating this score, namely (a) monitoring a building's water pipes for legionella risk and (b) monitoring the desk occupancy in a building.

The general field is therefore that of ‘smart’ buildings. Smart buildings include networks of electronic sensors designed to monitor the environment in a building for improved occupant comfort, efficient operation of building systems, reduction in energy consumption, reduced operating and maintaining costs, increased security, historical performance documentation, remote access/control/operation, and improved life cycle of equipment and related utilities. The term ‘building’ should be expansively construed to cover any environment that people occupy or use.

### 2. Description of the Prior Art

Smart buildings offer the promise of buildings that provide much improved levels of health and happiness for their users, compared with conventional buildings. Factors such as occupancy density, cleanliness, air quality, and lighting level all affect health and happiness. Given the increasing need to satisfy those who work in offices and other buildings, many companies have in recent years taken a strong interest in what constitutes an optimal level of these factors.

Smart buildings offer the promise of environments that are not only healthier and happier places to work, compared with conventional buildings, but are also more environmentally friendly, and more efficient in terms of energy usage and carbon footprint.

Smart buildings require sophisticated monitoring systems because the first step to improving a building environment is measurement or monitoring that environment, giving companies a view into how spaces are currently used and what their current performance is, using parameters that are relevant to healthier, happier, and more energy efficient buildings.

Research at the Harvard University School of Public Health identifies nine foundations or parameters for a “healthy building”: see www.9foundations.forhealth.org. These parameters are:
Ventilation
Air Quality
Thermal Health
Moisture
Dust and Pests
Safety and Security
Water Quality
Noise
Lighting and Views

Until now, measurement and analysis of these parameters has been a costly, manual and inefficient process. As a consequence, checks are typically done irregularly; the data produced is unreliable, inconsistent and fails to provide data of sufficient quality or that is actionable—i.e. can be readily interpreted and acted on.

Even if a company does have accurate and reliable measurements of one factor, such as building occupancy, the data is insufficient if the organization is unable to cross-reference and compare it to other contributing factors, such as air quality and cleanliness. Moreover, organizations have little or no context into how they compare against their peers, which would help inform their priorities and give a true understanding of where their buildings are under performing.

The technical challenges have been to cheaply, efficiently and reliably collect, measure and automatically analyse these parameters and to automatically present the analysis in a way that gives readily understood and useful insights that can be acted on. These challenges make it difficult for organizations to implement positive changes to the buildings they control, to improve the health, happiness and general welfare of the building occupants and to improve the buildings' energy efficiency.

### SUMMARY OF THE INVENTION

The invention is implemented in the Infogrid ‘healthy building score’ system. In the Infogrid system, a building includes a number of IoT sensors, each measuring an environmental parameter, such as temperature, humidity, noise, light levels, CO2 levels etc. The environmental parameter data from these sensors is then automatically processed using a computer-implemented scoring algorithm that aggregates the environmental parameter data into a ‘healthy building score’. The scoring algorithm is a hierarchical algorithm in which there is a hierarchy of physical locations, such as floor of a building, then a room in a building, then an area in a room, then the specific sensor(s) in that area; the sensors are hence at the lowest level of the hierarchy. The environmental performance scores of all sensors are aggregated to give a healthy building score, which is displayed on a computer user interface. The user interface can also display a schematic or other representation of the building layout or floor plan, enabling a user to see the location of all sensors and see their individual environmental performance score. The user interface can also display time-based trends in the healthy building score as well as other useful information, such as predicted issues (e.g. predicting low humidity in a building for later that day, hence enabling remedial action to be taken ahead of time). The user interface also collects together key metrics for other environmental parameters for the building, such as overall occupancy, air quality, predicted issues and many others metrics. This enables the holistic, overall healthy building score to be seen at a glance, together with more granular environmental information.

We can generalise the invention to a method of monitoring a building is, comprising the steps of:
(a) using a network of sensors in the building to measure multiple different environmental parameters;
(b) automatically processing the environmental performance parameters, using a scoring algorithm running on a processor, to generate an overall healthy building score.

Optional features deployed in implementations of the invention: (note that any one or more of these optional features can be combined with any one or more other optional features).

The healthy building score
the environmental performance parameters include values for one or more of the following: ventilation; air quality; thermal health; moisture; dust; safety; water quality; noise; lighting; legionella compliance; desk occupancy.
the environmental performance parameters include values for, or related to, one or more of the following: CO2; radon; volatile organic compounds; particulate matter (including dust); humidity; air pressure; light levels; air temperature; localised temperature below a desk; noise levels; presence of water; water leaks; water quality; water pipe temperature; legionella compliance; cold storage compliance; proximity of objects (such as for measuring whether doors, vents, windows are open or closed); desk occupancy; room occupancy; button presses (such as for registering occupant satisfaction on a feedback panel); compliance with a cleaning regime.
one or more of the sensors each automatically generate or are otherwise associated with an environmental performance score that depends on the value of the environmental parameters measured by the sensor;
the method includes automatically processing the environmental performance parameters, using a scoring algorithm running on a processor
the method includes automatically processing the environmental performance parameters, using an AI, e.g. deep learning system, trained to generate the healthy building score.
the environmental performance score of a sensor is derived from the proportion of time a sensor's reading is spent outside of a defined optimal (or healthy) range for that sensor's reading type.
the environmental performance score of a sensor is weighted depending on how recently the sensor has generated that score.
the overall healthy building score is calculated and updated each day, using data from a set, preceding number of days, e.g. the preceding 30 days.
the scoring algorithm aggregates the environmental performance scores from multiple sensors, measuring multiple different environmental parameters.
the scoring algorithm uses a hierarchical algorithm in which the hierarchy is based both on the type of the sensor measurement and its relative spatial location within a building.
the hierarchy allows for a query-able and extensible format.
the scoring algorithm organises sensors into a hierarchy of physical locations, such as floor of a building, then a room in a building, then an area in a room, then specific sensor(s) in that area.
the scoring algorithm is a hierarchical algorithm in which the type of sensor or parameter is placed at the first or lowest level of the hierarchy.
the environmental performance scores of sensors are aggregated to give a queryable score for one or more hierarchies of physical locations, e.g. an aggregated score for the sensors of a specific type in an area; an aggregated score for sensors of that specific type in a room containing that specific area; an aggregated score for sensors of that specific type in a floor including that room; an aggregated score for sensors of that specific type across all floors.
the environmental performance scores of sensors are aggregated to give a healthy building score, being an overall healthy building score that is a single score or value, and that single store or value is an aggregated score for sensors across all types and across all floors.

### Sensors

the network of sensors includes sensors that are data-connected sensors (e.g. wireless IoT or ethernet sensors) designed to measure a specific parameter and generate or result in an environmental performance score for that parameter.
the network of sensors includes sensors that are wireless connected devices that send data wirelessly to an external computing device via a hub.
the network of sensors is capable of measuring directly or indirectly at least some of the following environmental parameters: ventilation; air quality; thermal health; moisture; dust; safety; water quality; noise; lighting; legionella compliance; desk occupancy.
the sensors are capable of directly measuring at least some of the following parameters:
CO2; radon; volatile organic compounds; particulate matter (including dust); humidity; air pressure; light levels; air temperature; localised temperature below a desk; noise levels; presence of water; water leaks; water quality; water pipe temperature; legionella compliance; cold storage compliance; proximity of objects (such as for measuring whether doors, vents, windows are open or closed); desk occupancy; room occupancy; button presses (such as for registering occupant satisfaction on a feedback panel); compliance with a cleaning regime.
the network of sensors includes sensors inside the building, and one or more of the following locations: on external walls or roofs of the building; wholly external to the building; in the local neighbourhood in which the building is situated, distant from the local neighbourhood in which the building is situated.
the network of sensors includes one or more sensors that infer a parameter, such as water quality, by directly measuring a different parameter, such as water temperature.
a water pipe temperature sensor, attached to a water pipe, generates data analysed by a computer running a deep learning algorithm trained to predict or infer whether conditions in the water pipe, based on temperature data sent from the temperature sensor, are or are not conducive to the growth of legionella bacteria.
a water pipe temperature sensor, attached to a water pipe, generates data analysed by a computer running configured to predict or infer whether conditions in the water pipe, based on temperature data sent from the temperature sensor, are or are not conducive to the growth of legionella bacteria.
a temperature sensor is configured to detect the air temperature at a location and to send temperature data for receipt by a remote computer; and a computer implemented AI (e.g. deep learning) system running on a remote computer, that has been trained to predict or infer whether a person was or was not at the location based on air temperature data sent from the temperature sensor, analyses the temperature data.
a temperature sensor is configured to detect the air temperature at a location and to send temperature data for receipt by a remote computer; and a computer implemented system running on a remote computer configured to predict or infer whether a person was or was not at the location based on air temperature data sent from the temperature sensor, analyses the temperature data.

### The User Interface

the overall healthy building score is displayed on a computer user interface, and the user interface also display a schematic or other representation of the building layout or floor plan.
the schematic or other representation of the building layout or floor plan in the user interface shows the type of sensors in a given area and the aggregated scores for each type of sensor.
the user interface displays when the data from a sensor was last updated.
the user interface displays the wireless signal strength associated with a sensor.
the user interface gives a schematic presentation of one or more floor plans for the building, the floor plan including icons representing one or more of: desks, chairs, tables, sofas, kitchens, bathrooms, and user can select an area in the floor plan and a summary of the sensor data for that selected area.
the user interface includes a numeric, percentage representing the overall healthy building score.
the user interface includes a graphic or icon, and the size of shape of one part or section of the graphic or icon relative to a different part or section of the graphic or icon represents the overall healthy building score.
the user interface includes a circle, with the length of an arc in the circle representing the strength of the overall healthy building score.
the user interface includes a graphic representation of the time-based trend of the overall healthy building score.
the user interface includes data showing the current (e.g. today) and previous (e.g. yesterday and 30 days ago) values of the environmental performance scores that contribute to the overall healthy building score.
the user interface includes an option that when selected shows the overall healthy building scores of other buildings or environments.
an end-user defines the content of the user interface by selecting from a number of different widgets (namely an application, or a component of an interface, that enables a user to perform a function or access a service), the widgets including one of more of the following: Desk occupancy; Touch count; Proximity count; Proximity and Touch Count; Cubicle occupancy stoplight; People counting stoplight; floor plan; indoor air quality; desk occupancy heatmap; pipe monitoring (e.g. L8 Legionella risk or compliance); water leak detection; daily predicted issues; healthy building score; smart cleaning; CO2 concentration; office usage; bathroom visits counter; cold storage compliance.
the user interface displays indoor air quality on a per room basis, with an overall average, and also individual parameters including one or more of: CO2, virus risk, temp, humidity, temperature, air pressure, particulate matter, TVOC, noise.
the user interface displays a cleaning widget where a user can define how many times a space, such as a toilet, is used before it is cleaned and sensors automatically count usage and the system then automatically determines if the space needs cleaning, and the cleaning status of the space is shown on the user interface, e.g. on a floor plan that shows the location of the space.
the user interface displays a desk occupancy heatmap that graphically represents the level of desk occupancy as a function of day of the week and time.
the user interface displays an automatically generated description of one or more predicted issues or problems associated with environmental performance scores that exceed thresholds.
the user interface is implemented by a web app.
the user interface is configured to automatically display an alert if one or parameters satisfy a predefined condition.

### Cross-Functionality

the environmental parameters measured by the sensor or sensors are processed by a computer system configured to process different types of environmental parameters to automatically identify correlations or linkages between different types of environmental parameters and then automatically generating actions and/or recommendations based on the correlations or linkages, and displaying the actions and/or recommendations on a user interface.
the environmental parameters measured by the sensor or sensors are processed by a computer system configured to generate actions and/or recommendation based on combining different types of environmental parameters.
the computer system is configured to combine the environmental parameters of temperature data from water pipe temperature sensors, analysed for legionella compliance, with the environmental parameter of room usage.
the computer system is configured to combine the environmental parameters of temperature data from water pipe temperature sensors, analysed for legionella compliance, with the healthy building score.
the computer system is configured to combine the environmental parameters of temperature data from water pipe temperature sensors, analysed for legionella compliance, with the healthy building score and to automatically display predicted issues relating to potential legionella non-compliance.

A second aspect is:

A system for monitoring a building, the system receiving data from a network of sensors in the building configured to provide environmental performance parameters; in which the system includes a computer running a scoring algorithm that processes the environmental performance parameters to automatically generate an overall healthy building score.

A third aspect is: A method of tracking how the healthiness of a building changes over time; including the step of regularly or repeatedly applying the method defined above.

We will refer to the above aspects as ‘Key Feature A’—so Key Feature A covers, in one implementation, using the data from multiple environmental sensors to automatically generate an overall healthy building score.

We also disclose a number of other Key Features, which we summarise below. Note that any of these Key Features can be combined with any one or more other Key Features, and with any one or more of the optional features given earlier.

We summarise the twelve Key Features A-L as follows:
Key Feature A: Healthy building score
Key Feature B: Smart floor plan user interface
Key Feature C: Environmental Scores with time stamp
Key Feature D: Widgets user interface
Key Feature E: Air quality user interface
Key Feature F: Smart Cleaning widget user interface
Key Feature G: Heatmap user interface
Key Feature H: Predicted issues user interface
Key Feature I: Cross-functionality
Key Feature J: Legionella Compliance (see Appendix 2)
Key Feature K: Desk occupancy monitoring (See Appendix 3)
Key Feature L: AI trained virtual sensor

Key Feature B: Smart floor plan user interface

The Infogrid System Enables a User to Upload Building Floor Plans; the Type and the Location of Various sensors is then manually or automatically added to the building floor plans; the Infogrid user interface shows the actual location of all sensors on a floor plan, together with the measured data from the sensors; this data can be shown next to the related sensor, or can be shown in a pop up window when the sensor is selected in the user interface.

We can generalise to:

A method of automatically monitoring the environmental performance of a building, comprising the steps of:
(a) using a network of sensors located in the building and configured to measure multiple different environmental parameters;
(b) automatically processing the environmental parameters on a processor and generating a user interface that graphically displays a schematic representation of the building layout(s) or floor plan(s), including the type of sensors in a given location and the values of the measured environmental parameters for one or more of the sensors.

A system for monitoring the performance of a building, the system receiving data from a network of sensors in the building and configured to provide environmental parameters; in which the system includes a computer (i) configured to processes the environmental parameters and (ii) configured to generate a user interface that graphically displays a schematic representation of the building layout(s) or floor plan(s), including the type of sensors in a given location and the values of the measured environmental parameters for one or more of the sensors.

Key Feature C: Environmental Scores with Time Stamp

The Infogrid system captures data from a broad range of different types of sensors, including wireless IoT sensors. Data from these sensors can be regularly and automatically pushed from these sensors, or pulled by a data hub; in any event, it is very helpful for the user analysing the data to be able to know how reliable and up to date the data is. So the Infogrid system captures when the data from a sensor was last updated and displays that in the user interface next to the last reading from that sensor.

We can generalise to:

A method of automatically monitoring the environmental performance of a building, comprising the steps of:
(a) using a network of sensors in the building and configured to measure multiple different environmental parameters;
(b) automatically processing the environmental parameters on a processor and generating a user interface that graphically displays the location of the sensors, the values of the measured environmental parameters and when the data from one or more of the sensors was last updated.

A system for monitoring the performance of a building, the system receiving data from a network of sensors in the building configured to measure multiple different environmental parameters; in which the system includes a computer (i) configured to processes the environmental parameters and (ii) configured to generate a user interface that graphically displays the location of the sensors, the values of the measured environmental parameters and when the data from one or more of the sensors was last updated.

Key Feature D: Widgets user interface

The Infogrid system is a flexible system that can capture data from many different types of sensors, and can analyse that data and enable it to be used in many different ways. It is also expandible: new and different types of sensors, and new and different ways of analysing and using the data from any sensors are regularly introduced. To enable a simple and easy way for users to understand this scope and also flexibility, the Infogrid system presents a number of user-selectable widget options on the user interface: a widget is an application, or a component of an interface, that enables a user to perform a function or access a service. The widgets include one of more of the following types of widget: desk occupancy; desk occupancy heatmap; touch count; proximity count; proximity and touch count; cubicle occupancy stoplight; people counting stoplight; floor plan; indoor air quality; pipe monitoring (e.g. L8 Legionella risk or compliance); water leak detection; water pipe temperature; daily predicted issues; healthy building score; smart cleaning (e.g. including setting, and compliance with, a cleaning regime); CO2 concentration; office usage; bathroom visits counter; cold storage compliance.

This enables rapid and easy to understand customisation of the system to meet the needs of a specific user, or specific building management team. And old widgets can readily be removed, and new ones added, making the system easy to learn and to customise.

We can generalise to:

A method of automatically monitoring the environmental performance of a building, comprising the steps of:
(a) using a network of sensors in the building and configured to measure multiple different environmental parameters;
(c) processing the environmental parameters on a processor and generating a user interface that graphically displays a number of user-selectable widget options, where a widget is an application, or a component of an interface, that enables a user to perform a function or access a service, the widgets including one of more of the following types of widget: desk occupancy; desk occupancy heatmap; touch count; proximity count; proximity and touch count; cubicle occupancy stoplight; people counting stoplight; floor plan; indoor air quality (e.g. CO2; radon; volatile organic compounds; particulate matter (including dust); humidity; air pressure; air temperature); pipe monitoring (e.g. L8 Legionella risk or compliance); water leak detection; water pipe temperature; daily predicted issues; healthy building score; smart cleaning (e.g. including setting, and compliance with, a cleaning regime); office usage: bathroom visits counter; cold storage compliance.

A system for monitoring the performance of a building, the system receiving data from a network of sensors in the building configured to provide environmental parameters; in which the system includes a computer (i) configured to processes the environmental parameters and (ii) configured to generate a user interface that graphically displays a number of user-selectable widget options, where a widget is an application, or a component of an interface, that enables a user to perform a function or access a service, the widgets including one of more of the following types of widget: desk occupancy; desk occupancy heatmap; touch count; proximity count; proximity and touch count; cubicle occupancy stoplight; people counting stoplight; floor plan; indoor air quality (e.g. CO2; radon; volatile organic compounds; particulate matter (including dust); humidity; air pressure; air temperature); pipe monitoring (e.g. L8 Legionella risk or compliance); water leak detection; water pipe temperature; daily predicted issues; healthy building score; smart cleaning (e.g. including setting, and compliance with, a cleaning regime); office usage; bathroom visits counter; cold storage compliance.

### Key Feature E: Air Quality User Interface

The Infogrid system captures a range of detailed air quality parameters and analyses these to generate an overall air quality score; this can be a single number or other score to provide an easy to grasp summary. It can be made up of an average of the constituent scores, or an average where different weights are given to different constituents (for example, the particulate matter or TVOC (total volatile organic compounds) scores could be weighted as more important than say the air pressure score, since these have a larger impact on health). In addition, the constituent scores are also displayed, so a user can, at a glance, look at specific parameters of interest.

We can generalise to:

A method of automatically monitoring the environmental performance of a building, comprising the steps of:
(a) using a network of sensors located in the building and configured to measure multiple different air quality parameters;
(b) processing the data from the sensors on a processor and generating a user interface that graphically displays indoor air quality on a per room basis, with an overall air quality score, and also individual parameters including one or more of: CO2, virus risk, humidity, temperature, air pressure, particulate matter, TVOC, noise.

A system for monitoring the performance of a building, the system receiving data from a network of sensors in the building configure to measure multiple different air quality parameters; in which the system includes a computer (i) configured to processes the data from the sensors on a processor and to generate a user interface that graphically displays indoor air quality on a per room basis, with an overall average, and also individual parameters including one or more of: CO2, virus risk, temp, humidity, temperature, air pressure, particulate matter, TVOC, noise.

### Key Feature F: Smart Cleaning Widget User Interface

The Infogrid system enables automated ‘smart cleaning’, namely intelligently working out when specific rooms should be cleaned, for example based on their actual usage (so a toilet that is busy—e.g. with multiple and frequent triggers of a sensor that determines if the door to the toilet is opened) or predicted usage (e.g. historic data shows that when desk occupancy in one part of a building exceeds a threshold, the closest toilets are busy). So the Infogrid enables the building manager etc to accurately identity key areas that need cleaning attention; this not only ensures a hygienic building, but also maximises the efficient of the cleaning team, compared with the conventional approach of regularly scheduled cleaning slots throughout the day. Toilets can also be equipped with IoT connected touch panels or buttons that enable anyone to signal whether soap or toilet paper needs replacing; these touch panels can also be used by cleaners to signal the start and end of their cleaning, giving accurate feedback.

We can generalise to:

A method of automatically monitoring the environmental performance of a building, comprising the steps of:
(a) using a network of sensors in the building, and configured to automatically monitor or count usage of a space, such as a toilet, room, corridor or other part of a building;
(b) generating a user interface that graphically displays a cleaning widget configured to enable a user to define how many times a space, can be used before it is cleaned;
(e) automatically processing the data from the sensors to determine if the space needs cleaning, and displaying whether or not the space needs cleaning on the user interface, e.g. on a floor plan that also shows the location of the space.

A system for monitoring the performance of a building, the system receiving data from a network of sensors in the building, each configured to automatically monitor or count usage of a space, such as a toilet, room, corridor or other part of a building; in which the system includes a computer (i) configured to generate a user interface that graphically displays a cleaning widget configured to enable a user to define how many times a space, such as a toilet, can be used before it is cleaned;

and the system is configured to automatically process data from the sensors to determine if the space needs cleaning, and to display whether or not the space needs cleaning on the user interface, e.g. on a floor plan that also shows the location of the space.

### Key Feature G: Heatmap User Interface

The Infogrid tracks occupancy in several different ways; for example, whether individual desks are occupied (see Appendix 3) to more general people counting. Desk occupancy is especially useful to track since it affects many aspects of building operations (e.g. how busy nearby toilets are likely to be, which in turn affects how cleaning teams should be organised; which desks should be cleaned at the end of the day; whether social distancing rules are being complied with etc.). To enable a user of the Infogrid system to rapidly understand desk occupancy levels, the Infogrid system represents desk occupancy as a heatmap. A heatmap is a data visualization technique that shows the magnitude of a phenomenon (e.g. desk occupancy) as a colour, organised in a two dimensional grid or other representation. The desk occupancy heatmap has day of the week running up the Y axis, and time of day running along the X axis: 1 hour slots are formed into a rectangular grid, with darker shades corresponding to higher occupancy.

We can generalise to:

A method of automatically monitoring the environmental performance of a building, comprising the steps of:
(a) using a network of air temperature sensors positioned to measure local air temperature below a desk or table;
(b) processing the air temperature data on a processor and generating a user interface that graphically represents the level of desk occupancy as a function of day of the week and time of day, such as a heatmap.

A system for monitoring the performance of a building, the system receiving data from a network of air temperature sensors, each positioned to measure local air temperature below a desk or table; in which the system includes a computer configured to process the air temperature data to generate a user interface that graphically displays a desk occupancy heatmap that represents the level of desk occupancy as a function of day of the week and time of day.

### Key Feature H: Predicted Issues User Interface

The Infogrid system automatically analyses data from a sensor and determines whether the associated environmental parameter is within its acceptable threshold or not: it can predict what a future value of that parameter might be. For instance, if the air temperature in a room early in the morning is already nearing its acceptable maximum, the system can determine that, once the room is fully occupied, then the temperature limit will be exceeded. It can flag this as a potential issue in the user interface, and suggest remedial action (e.g. from a library of candidate actions), such as requiring new users of that room to instead find an alternative room to use.

We can generalise to:

A method of automatically monitoring the environmental performance of a building, comprising the steps of:
(a) using a network of sensors located in the building and configured to measure multiple different environmental parameters;
(b) processing the environmental parameters to generate a user interface that graphically displays an automatically generated description of one or more predicted issues or problems associated with environmental parameters that exceed thresholds, together with an automatically generated description of potential remedial action.

A system for monitoring the performance of a building, the system receiving data from a network of sensors in the building and configured to measure multiple different environmental parameters; in which the system includes a computer (i) configured to process the environmental parameters and (ii) configured to generate a user interface that graphically displays an automatically generated description of one or more predicted issues or problems associated with environmental parameters that exceed a defined threshold, together with an automatically generated description of potential remedial action.

### Key Feature I: Cross-Functionality

The Infogrid system automatically analyses data coming from multiple different types of sensors; these can be reporting a wide variety of different environmental parameters. The system is trained (e.g. using AI, e.g. deep learning) to automatically identify correlations or linkages between different types of environmental parameters and to then automatically generate actions and/or recommendations based on the correlations or linkages.

For example, the system can combine legionella L8 compliance (based on water pipe temperature sensors) with smart cleaning (based on sensors that track room usage—e.g. bathroom/kitchen door opening sensors): if a water pipe in a kitchen etc. looks close to legionella non-compliance, then that feeds into the smart cleaning process, steering cleaning staff to prioritise cleaning that kitchen etc. and running those taps for the prescribed amount to eliminate legionella risk.

Another example: the Infogrid system can combine legionella compliance with healthy building scoring (Key Feature A) and the Predicted Issues widget: since legionella non-compliance would have a major negative impact on any healthy building score, and has to be avoided as a matter of priority, the predicted issues algorithm can heavily weight any legionella non-compliance risk when generating its predicted issues for the coming day (or hours etc): even a small risk of legionella noncompliance can be escalated to show a predicted major impact on the future healthy building score via the predicted issues widget, ensuring that focus is given to eliminating the legionella non-compliance risk.

Another example: the system can combine desk occupancy monitoring (see Appendix 3: based on air temperature sensors placed under desks) with smart cleaning (specifically the frequency of cleaning schedule the user can define in the smart cleaning widget): if desk occupancy indicates high usage of an area, or predicts future high usage, then the smart cleaning schedule can automatically be adjusted (or the user can be prompted to consider doing so using the Predicted Issues widget) for additional cleaning before the busy period, and/or immediately after it ends (this assumes it is preferable not to close off a toilet during a high occupancy period since that would inconvenience more people than if cleaning is done outside of the busy period).

Another example: the system can combine humidity data with the desk occupancy heatmap and the Predicted Issues widget: if current or predicted humidity looks uncomfortably high in an area of a building, and the desk occupancy heatmap predicts a busy period with lots of people later that day, then the predicted issues widget can suggest pre-emptively increasing the air conditioning speed for that area during that busy period.

We can generalise to:

A method of automatically monitoring the performance of a building, comprising the steps of:
(a) using a network of sensors located in the building and configured to measure multiple different types of environmental parameters;
(b) processing different types of environmental parameters to automatically identify correlations or linkages between different types of environmental parameters and then automatically generating actions and/or recommendations based on the correlations or linkages, and displaying the actions and/or recommendations on a user interface.

A system for automatically monitoring the performance of a building, the system receiving data from a network of sensors in the building and configured to measure multiple different types of environmental parameters; in which the system includes a computer (i) configured to process different types of environmental parameters and (ii) configured to automatically identify correlations or linkages between different types of environmental parameters and then automatically generate actions and/or recommendations based on the correlations or linkages, and display the actions and/or recommendations on a user interface.

### Key Feature J: Legionella Compliance (See Appendix 2)

The Infogrid system can automatically analyse data from low-cost IoT wireless temperature sensors attached to water pipes to determine if conditions in the water pipe, are or are not conducive to the growth of legionella bacteria: bacterial growth occurs in stagnant water sitting at between 20-45° C. for more than a threshold time. An AI-based system can be trained on sets of data from temperature sensors on water pipes across a broad range of conditions (water flow; water temperature). Alerts can be generated automatically if it looks like a particular pipe is approaching the threshold at which it would no longer be compliant with the applicable regulations: a cleaning team can then be tasked with opening the associated water tap.

We can generalise to:

A system for monitoring the control of legionella bacteria in a water system in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether conditions in the water pipe, based on temperature data sent from the temperature sensor, are or are not conducive to the growth of legionella bacteria.

### Key Feature K: Desk Occupancy Monitoring (See Appendix 3)

The Infogrid system can automatically analyse data from low-cost IoT wireless air temperature sensors placed underneath desks and tables to determine if there is someone sitting at the desk or table. An AI-based system can be trained on sets of data from air temperature sensors across a broad range of conditions (air temperature; whether there is someone sitting at the desk/table or not).

We can generalise to:

A system for detecting the presence of a person at a specific location, the system including
(i) a temperature sensor configured to detect the air temperature at the location and to send temperature data for receipt by a remote computer;
(ii) a computer implemented AI (e.g. deep learning) system running on the remote computer and that has been trained to predict or infer whether a person was or was not at the location based on air temperature data sent from the temperature sensor.

### Key Feature L: AI Trained Virtual Sensor

We have seen in Key Feature J and K above how the Infogrid system can use the data from a sensor that measures one sort of variable to infer a different sort of variable. For example (see Key Feature J), the Infogrid system does not directly monitor legionella compliance, but instead the temperature of the water pipes that could become breeding grounds for legionella bacteria; the Infogrid system uses a deep learning based system to interpret the water pipe temperature data and infer water flow and water temperature conditions from that data. So we have what one might call a ‘virtual’ legionella compliance sensor. Similarly, the Infogrid system provides a ‘virtual’ desk occupancy sensor: it does not directly determine if a person is sitting at a desk, but instead detects the rise in air temperature under a desk if someone is sitting there; the Infogrid system uses a deep learning based system to interpret the air temperature and to infer the presence of someone sitting at the desk from that data.

We can generalise to:

A system for monitoring the value of an environmental parameter in a building, the system including:
(i) a sensor configured to measure a type of environmental parameter;
(ii) a computer implemented AI (e.g. deep learning) system running on a remote computer and that has been trained to predict or infer the value of a different parameter, based on the environmental parameter data from the sensor.

### BRIEF DESCRIPTION OF THE FIGURES

The invention is implemented in the Infogrid system and the figures illustrate the operation of this system.

FIGS. 1 and 2 show the hierarchical scoring algorithm used in creating Healthy Building Scores.

FIG. 3 shows how air quality particulate readings are used in creating Healthy Building Scores.

FIG. 4 shows the hierarchical folder structure used in the system

FIGS. 5-6 shows the window that enables different widgets to be selected for the dashboard, or user interface.

FIGS. 7 and 8 show the dashboard as displayed on a typical PC screen, with multiple different widgets populated with environmental data.

FIG. 9 shows the Healthy Building Score widget.

FIG. 10 shows the Healthy Building Score widget with data compared across three different buildings.

FIG. 11 is a help screen for the Healthy Building Score widget.

FIGS. 12-13 shows the Smart Cleaning widget.

FIG. 14 shows the Today's Predicted Issues widget.

FIGS. 15 and 16 show the dashboard as displayed on a typical PC screen, with multiple different widgets populated with environmental data.

FIG. 17 shows the Floor Plan widget with desk occupancy data for a desk being shown.

FIG. 18 shows the Floor Plan widget with pipe monitoring data for a cold tap being shown.

FIGS. 19-20 show the dashboard as displayed on a typical PC screen, with multiple different widgets populated with environmental data.

FIG. 21 shows the sensor listing.

FIG. 22 shows the Recurrent Neural Network Model for the legionella compliance monitoring system, re-purposing pipe monitoring data.

FIG. 23 shows the Recurrent Neural Network Model for the desktop occupancy monitoring system, re-purposing air temperature data.

FIG. 24 charts the advantages that can flow from using different sensors in different use cases.

### DETAILED DESCRIPTION

The invention is implemented in the Infogrid system; this is a platform that combines inputs from many types of sensors; the Infogrid system is able to aggregate data from multiple sensor-based inputs regarding the factors contributing to a healthy building or internal space and to present these to e.g. entities responsible for building management, in a unified and holistic way on a simple user interface, or dashboard. The system typically uses a network of various types of low-cost, IoT wireless data connected sensors that can be distributed very extensively and cheaply throughout a building.

The Infogrid system uses very small, low cost wireless, data connected IoT sensors that typically take seconds to physically install and to configure on to the system. These sensors typically send environmental data every 5 to 15 minutes to a wireless hub, from where the data is sent (e.g. by a secure cellular link) to be processed by a cloud-based computing system. The sensors are battery powered, typically with a battery life of several years, e.g. up to 15 years. The cloud-based computing system analyses the data (in some cases using AI-trained algorithms) and the data and results can be viewed on a webapp, or can be sent via a standard API to a user's building management system. The Infogrid system can be configured to automatically send urgent alerts to users (e.g. building or facilities managers) via SMS or email etc.

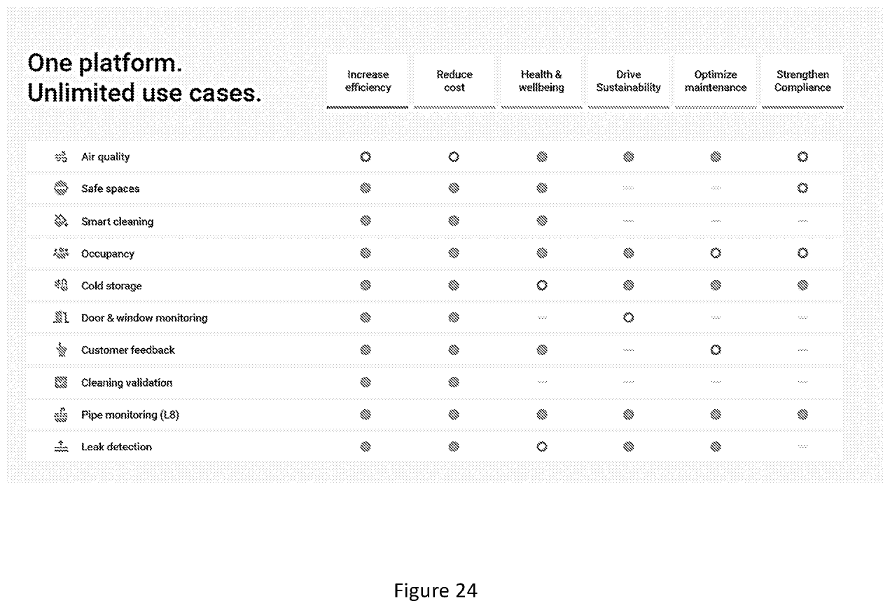

FIG. 24 lists some of the key monitoring functions available in the Infogrid system: air quality; safe spaces; smart cleaning; occupancy; cold storage; door and window opening; customer feedback; cleaning validation; pipe monitoring (L8); leak detection. It then maps each of these to different benefits: increased building monitoring efficiency; reduced costs in building operations; enhanced health and wellbeing for staff; enhanced sustainability; optimised maintenance; strengthened compliance. We can expand on each of these benefits as follows.

Increased efficiency the Infogrid system can automate manual tasks, e.g. to remove the burden of manual tasks and site visits, to provide real-time alerting, to increase team productivity, to save time by monitor a building estate remotely and overall to enable better decisions to be made faster. Alerts that flag issues can be easily configured to meet a user's specific, custom requirements.

Reduce costs: the Infogrid system enables a user to optimize the buildings they monitor, e.g. to enable the actual, real-time use being made of a building (down to an individual room and even desk level) and optimize usage, reduce energy consumption, reduce unnecessary cleaning, by closing-down unused areas. Remote monitoring reduces the need for engineer visits and their travel time.

Improved health & wellbeing: the Infogrid system provides demonstrably (i.e. as shown by sensor data) safe and clean spaces, that lead to increased productivity, reduced sick leave, and enhanced decision-making abilities for building occupants, together with accurate, real time understanding of employee and customer satisfaction.

Enhanced sustainability: the Infogrid system enables reduced energy consumption and a lowered carbon footprint (e.g. by not heating or ventilating areas that are not occupied; by more accurately tracking temperature to avoid over-heating).

Optimised maintenance: the Infogrid system minimises the need for manual checks with 24/7 data and remote monitoring; enables rapid preventative maintenance (e.g. early detection of leaking water pipes; early detection of e.g. temperatures that are too low, or VOCs that are too high).

Strengthened compliance: the Infogrid system provides data and feedback to ensure that buildings are clean and safe, with automated compliance reporting, e.g. including exported reports featuring sensor data with 24/7 monitoring.

The Infogrid system uses complex algorithms to recommend actions to improve the total health of the building, with the proper optimisations of each foundational measure. However in order to algorithmically optimise, we must first arrive at a metric. In order to do this we have developed internally a scoring system which returns a single metric that allows clients to understand what is the overall “healthiness” of their workspace with a single number (the ‘Healthy Building Score’) against which they can judge their own performance and improvement over time, as well as compare themselves with others.

### The Hardware

Essentially all sensor hardware used in the Infogrid system can serve as inputs to the system, and hence also to building an accurate Healthy Building Score and it is expected that any future sensor hardware would similarly be incorporated to improve the accuracy or comprehensiveness of the score.

The system currently includes low-cost IoT sensors capable of directly or indirectly measuring the following; we include in square brackets the related parameter from the list of nine foundations listed earlier:
CO2 [Ventilation, Air Quality]
Radon [Safety]
Volatile Organic Compounds [Ventilation, Air Quality]
Particulate Matter (including dust) [Ventilation, Air Quality, Dust]
Humidity [Ventilation, Air Quality, Moisture]
Air Pressure [Air Quality]
Light level [Lighting]
Temperature [Thermal Health]
Noise level [Noise]
Presence of water [Moisture]
Proximity of objects (such as for measuring whether doors, vents, windows are open or closed) [Safety, Security, Ventilation]
Counting how many people are present in a room at any given time [Safety, Air Quality]
Button presses (such as for registering satisfaction on a feedback panel) [this is for indirect measures]

This covers essentially all of the nine foundations previously described, with the exception of direct measures of water quality, pest levels, and views—until such a time as direct measures of those would be incorporated these can be monitored indirectly.

Appendix 1 is a user guide to the Infogrid system, but we summarise some important features in the following section.

Air quality: The Infogrid system has specialist, small wireless IoT sensors that monitor CO2, VOCs, radon, humidity, light levels, ventilation, virus risk factors, air pressure, and a range of pollutants including particulate matter.

Water safety: The Infogrid system automatically monitors water movement and water temperature using low cost, small wireless IoT temperature sensors taped to water pipes; this reduces the need for labour-intensive processes to determine if pipes require flushing to reduce the risk of diseases such as legionella (see Appendix 2). The system can also detect leaks and prevent mold.

Occupancy: The Infogrid system tracks the movement of people to monitor space usage, control social distancing and limit access at the busiest times. It understands which rooms, desks and facilities are being used (see also Appendix 3 for a detailed description of the desk occupancy measuring system), when and for how long, to better utilise facilities and guide users to free space. The Infogrid system optimises the use of rooms and observation of social distancing measures by tracking the movement of people through spaces, and optimises maintenance team rotas, e.g. to ensure maintenance and support is provided where needed.

Smart cleaning: The Infogrid system enables tailored cleaning based on usage, to reduce costs and improve customer satisfaction. In addition, sensors can be used to validate when and where cleaning has taken place. The Infogrid system improves customer satisfaction and cleaning team efficiency by targeting effort to when and where it is needed most, increasing cleaning team efficiency and optimising cleaning rotas, and enabling automatic confirmation that cleaning equipment is being used.

Occupant feedback: The Infogrid system integrates feedback from employees and occupants (e.g. button presses to a feedback device) to help organizations quantify the impact they are having on their welfare and provide a ROI measurement on employee or customer satisfaction. Since feedback can be real-time, it enables faster response to customer signals, especially complaints, as well as trend spotting to identify systemic issues.

Leak detection: The Infogrid system enables the detection of faulty equipment and the prevention of damage to property by detecting flowing, pooling or dripping liquids where there should be none. This reduces health risks and hazards and can predict when assets are in need of repair before they break down.

Cold storage: The Infogrid system enables identifying when refrigerated products are outside of their desired temperature, with real-time 24 hour monitoring and automated alerts. It can predict when cold stores or fridges/freezers are need of repair, before they break down: preventative maintenance can save costs, protect stock and drive sustainability.

Other use cases: The Infogrid system can also integrate additional use cases including fire safety (e.g., keeping fire doors closed, fire walk-around compliance), unauthorised access, and a host of other healthy building measures.

The Infogrid system integrates the data from each of these sensors securely in the platform, providing organizations with a holistic view of their estate. It also provides companies with a score of where they stand in their healthy building journey, in comparison to their peers. This gives them a benchmark to make improvements against and—for the first time—the ability to quantify the impact of measures such as regular cleaning and air quality in the office, to reassure employees that it is a safe environment for them to return to. More importantly, with the new ability to have holistic oversight of their estate, companies can make long-term positive decisions that improve working conditions for their employees. It will help organizations demonstrate regulatory compliance, meet their ESG goals, and improve the sustainability of their buildings as well.

Infogrid's AI correlates the raw data generated by different sensors, unlocking the power of combining different use cases: for example, high occupancy, combined with very low external temperatures and low in-building humidity are good conditions for viral illnesses to spread: the Infogrid system can automatically predict this potential problem (see Feature H) and automatically suggest, or even automatically implement, remedial action. In this case, the system could automatically suggest, or even automatically implement, an increase in humidity, and a reduction in occupant density (e.g. automatically displaying a notice limiting the number of people allowed in lifts, or in washrooms; suggesting that occupants start social distancing because viral spreading risk is high etc).

### Healthy Building Score: Gathering Control Data

We will look now at the specifics of creating the Healthy Building Score.

We judge whether a measured Healthy Building Score level is “healthy” or “unhealthy” based on published research rather than conducting our own studies. There is extensive published guidance available such as from the World Health Organisation, the UK Healthy and Safety Executive, and other such national and supra-national agencies.

### Building an Algorithm

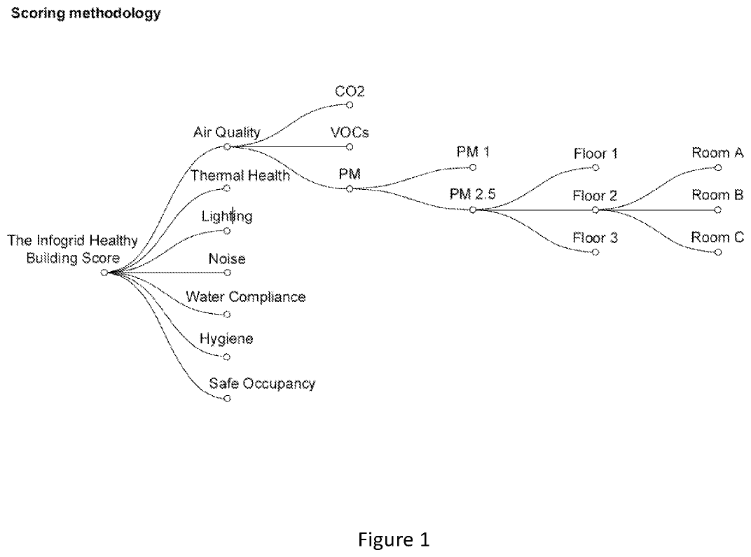

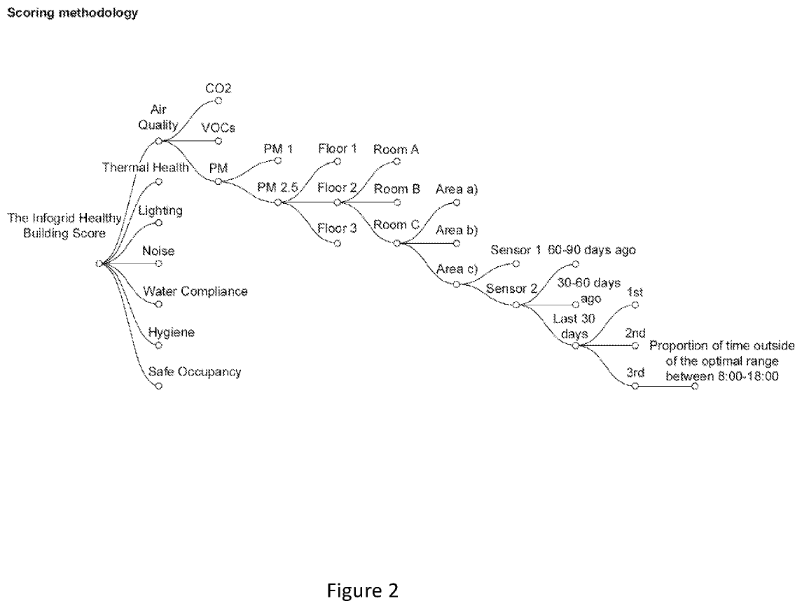

The principle of the development of the algorithm is based on a hierarchy which allows for a queryable and extensible format; the hierarchy is based both on the type of the sensor measurement and its relative spatial location within a building. This is summarised in the FIG. 1 and FIG. 2 charts, showing two levels of detail from which the total score is built.

We see from FIG. 1 and FIG. 2 that at the end of the hierarchy, the score is built from the proportion of time a sensor's reading is spent outside of the defined optimal (or healthy) range for that sensor's reading type (which we define here for working hours only, this is of course variable depending on the particular location type).

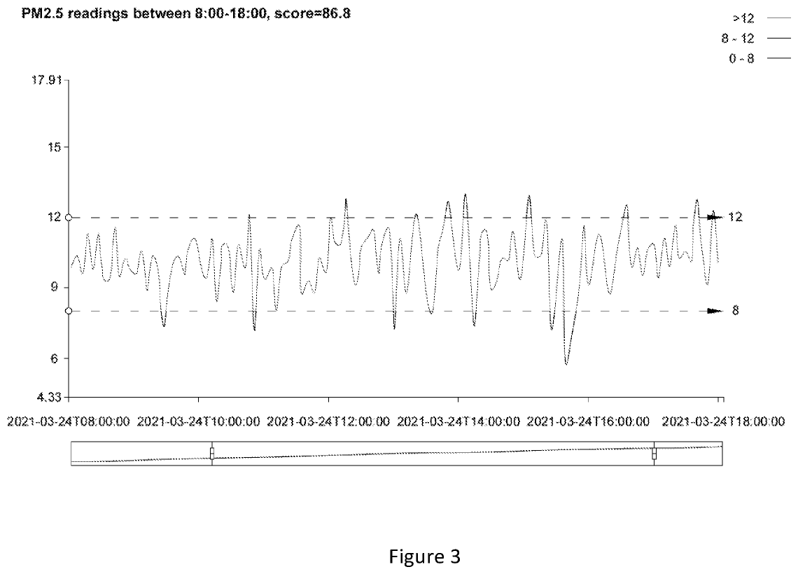

As an example, let us suppose that some measure (such as level of particulate matter) has a healthy range between 8 and 12 arbitrary units. Its variation throughout the day could be something like the FIG. 3 chart.

Finding that 86.8% of the time its readings are within the healthy range, we assign a score of 86.8 for that day. This score is stored alongside a history of such scores, which we can choose to weight, with a larger weight for the more recent scores. This would mean the score is not expected to show instantly an improvement or degradation, but rather give a value that is more representative of the recent typical ranges seen.

From this and an understanding of the spatial relationships between sensors, we then build up an idea of rooms and floors in a building as part of our hierarchy—such that each room in a floor may have a score, and this is then aggregated to give the total floor score (for example, by weighting based on the relative floorspace of each room). Then from floors we get the total building score for this particular measure, and we then again perform the same calculations for each of our other measures—all weighted according to their impact as based on a combination of the previously described research literature as well as considerations such as floor space etc, to finally arrive at one single score for the building as a whole.

Clients can of course choose to drill down into each layer of the calculation, in order to better understand the reasons behind their score and how to improve it. The Infogrid system is also able to supply actions (such as improving ventilation for example) likely to improve the score, and track whether or not taking those actions does indeed lead to measurable and statistically significant improvement over time or not.

### Productionising the Resultant Hardware and Software Combination

Calculations for the score are made from database queries of the stored sensor data and other software-based manipulations. The resultant scores at each level are then stored in database tables, in order to allow for later querying of each sub-level of the hierarchical relationships. The final score is then an aggregation of each level as previously described, also stored in a separate table. This result is then served as an API endpoint to Infogrid's WebApp frontend for display to clients.

### Infogrid's WebApp Frontend: The User Interface

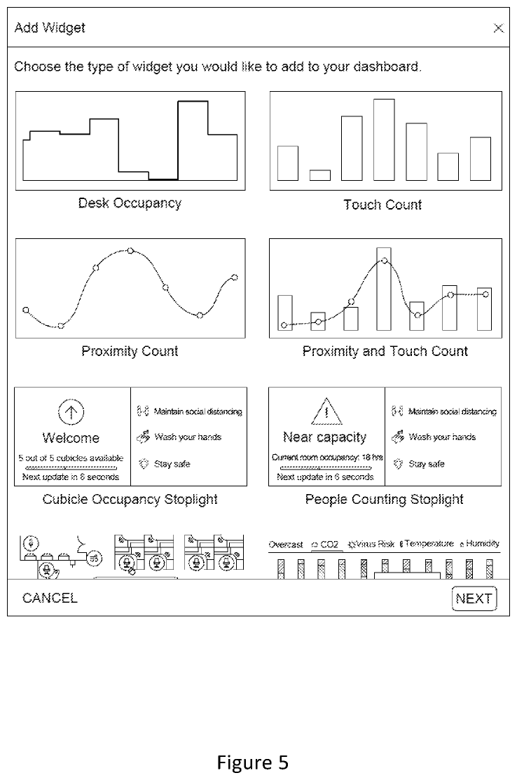

FIGS. 5-22 show the Infogrid WebApp frontend or the user interface. The user interface, or dashboard, is built up from a number of different widgets, or applications. These are selected from a widget selection window, shown in FIG. 5. The widget selection window shows a snapshot of the following widgets:
Desk occupancy: if selected, this populates the dashboard with a graph showing the desk occupancy as a function of time. Desk occupancy is measured using a temperature sensor positioned under a desk, as explained in more detail in Appendix 3.
Touch count: if selected, this populates the dashboard with a graph showing the number of touches to a feedback button sensor as a function of time.
Proximity Count: if selected, this populates the dashboard with a graph showing the numbers of people that trigger a proximity sensor as a function of time.
Proximity and Touch count: if selected, this populates the dashboard with a graph showing the numbers of people that trigger a proximity sensor and also touch the feedback button near the proximity sensor, as a function of time.
Cubicle occupancy stoplight: if selected, this populates the dashboard with an alert that is triggered if the number of people that occupy toilet cubicles meets a threshold: this alert would typically also be shown on a display outside the toilets, so that users can see that, e.g. all cubicles are occupied. Each cubicle includes an IR proximity sensor to determine if someone is present in the cubicle, whilst preserving personal privacy.
People counting stoplight: if selected, this populates the dashboard with an alert that is triggered if the number of people that occupy a room meets a threshold: this alert would typically also be shown on a display outside the room, so that users can see that, e.g. a toilet is nearly full or full. The toilet includes an IR proximity sensor that is triggered each time someone enters or leaves a room, or any other privacy preserving people counting technology.

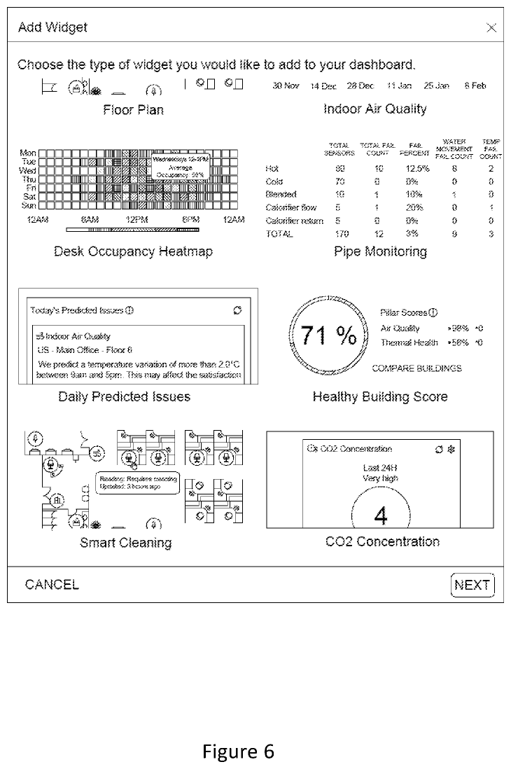

FIG. 6 continues the widget selection window.
Floor plan: if selected, this populates the dashboard with a floor plan of each floor of the building, typically including the location of toilets, taps, pipes, desks, sofas, lifts rooms etc, and including all sensors. It can include also each individual desk occupancy sensor, so that the status of each desk can be seen; this can be used to model and predict peak usage times, allocate available desks, optimise the use of space, and ensure social distancing.
Indoor air quality: if selected, this populates the dashboard with data from air quality sensors, e.g. sensors measuring air temperature, humidity, air pressure, CO2, particulate matter under 1 micron, particulate matter under 2.5 microns, TVOC (total volatile organic compounds), and virus risk.
Desk occupancy heatmap: if selected, this populates the dashboard with a heatmap graphically depicting differing levels of desk occupancy in a colour coded schematic, as a function of time, based on air temperature sensors placed under each desk. This can be used to model and predict peak usage times, allocate available desks, optimise the use of space, and ensure social distancing.
Pipe Monitoring: if selected, this populates the dashboard with data from the water pipe sensors, which are low cost temperature sensors; L8 (legionella) pipe monitoring is achieved; the data from the pipe sensors is automatically analysed to determine if water in a pipe has sat stagnant or tepid for too long and needs action. Water flow is inferred from rapid changes in the measured temperature.

The user interface dashboard shows real-time views on how many assets across a portfolio are likely to fail and when remedial action has been taken.
Daily predicted issues: if selected, this populates the dashboard with an automatically generated alert for potential issues or problems for the day ahead.
Healthy Building score: if selected, this populates the dashboard with the Healthy Building Score, together with the types of sensors that are used to contribute to that score, and a link to enable the Healthy Building Score for other buildings to be displayed.
Smart cleaning: if selected, this populates the dashboard with alerts that indicate which areas need cleaning, based on e.g. proximity sensors that detect people presence in an area and a user-defined schedule that links usage of an area with the desired cleaning frequency. Also, since individual desk occupancy is known, we can also focus cleaners' activities only on desks that have been used, helping to reduce cleaning times and costs.
CO2 concentration: if selected, this populates the dashboard with CO2 data from CO2 sensors.
Cold storage compliance: if selected, this populates the dashboard with temperature date from temperature sensors in cold storage units (e.g. for storing vaccines and other drugs), generating automatically an alert (e.g. SMS or email) if the temperature moves outside of the desire range to enable staff to respond.

Other widgets are possible and some of these will be shown in the Figures that shows the dashboard.

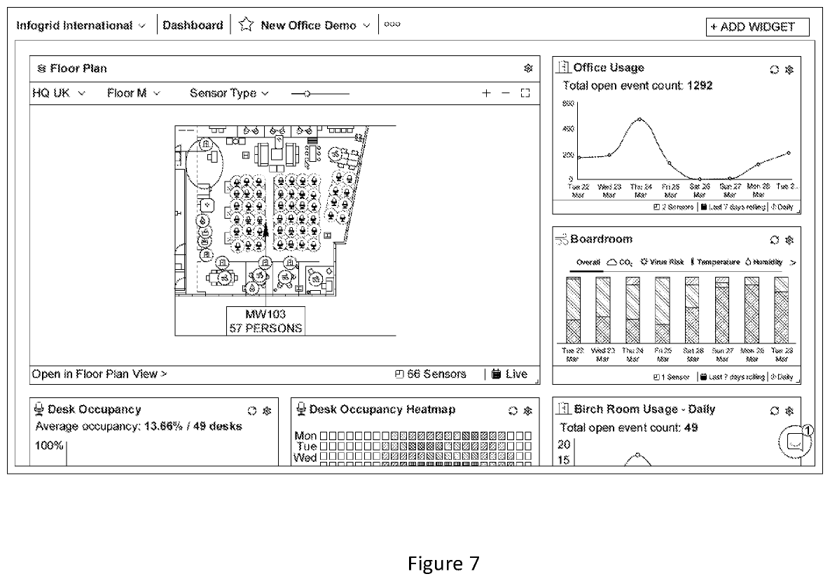

FIG. 7 shows part of a typical dashboard, showing the floor plan, an Office Usage widget (showing the number of people in a building as a function of time), a Boardroom air quality widget, a desk occupancy widget, a desk occupancy heatmap widget and ‘Birch Room usage widget.

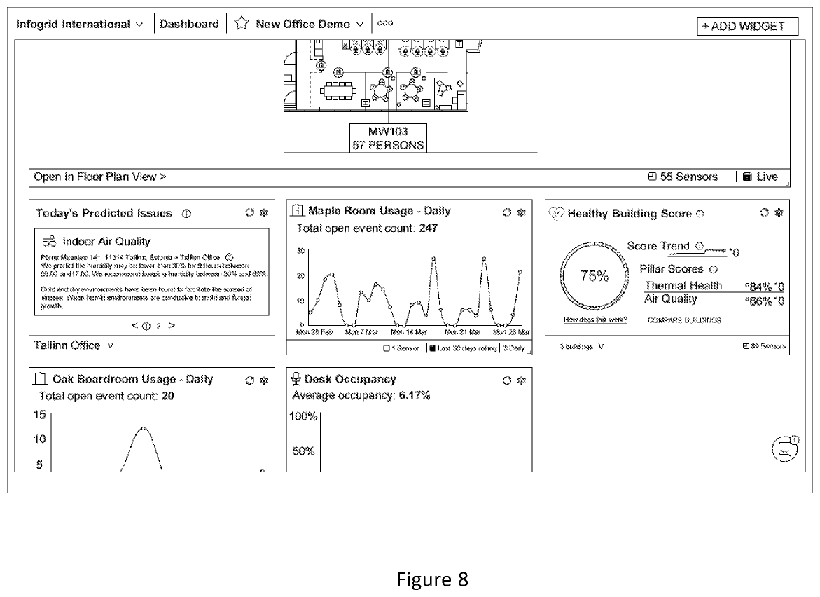

The user can scroll down and see further widgets, as shown in FIG. 8. FIG. 8 shows a part of a floor plan widget, a Today's predicted issues widget, a ‘Maple’ room usage widget, a Healthy building score widget, an ‘Oak’ boardroom usage widget, and a desk occupancy widget.

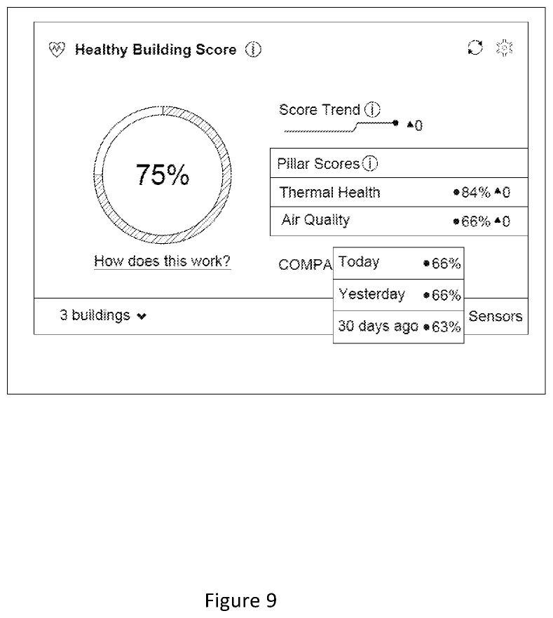

FIG. 9 shows the Healthy Building Score widget: it includes the actual numeric score (75% in this case), with a graphic representing this proportion (a perimeter of a circle that is 75% shaded). It shows the trend in the score (slightly rising) and also the types of sensors (called the ‘pillars’) that contribute to the score; in this thermal health and air quality are used. The actual thermal health and air quality scores are shown (84% and 66% respectively) and the user can select either to call up a pop-up window that shows related data: in this figure, the air quality item has been selected and the pop-up window shows the air quality score for today, yesterday and 30 days ago. The user can at a glance see that air quality is slowly improving.

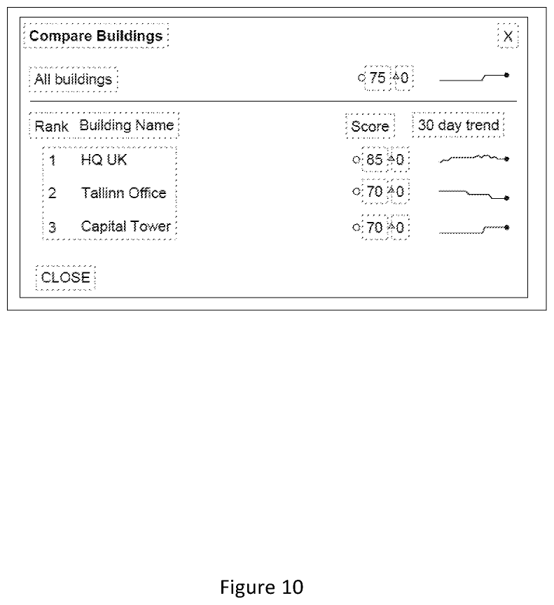

The widget also includes a link to Healthy Building Scores for other buildings, in this case 3 buildings: FIG. 10 shows the window that is displayed when this link is selected: the Healthy Building Scores for three buildings are shown in ranked order, with their 30 day trends. In this way, an organisation managing multiple buildings can see at a glance the Healthy Building Scores for their various buildings, empowering change and improvement.

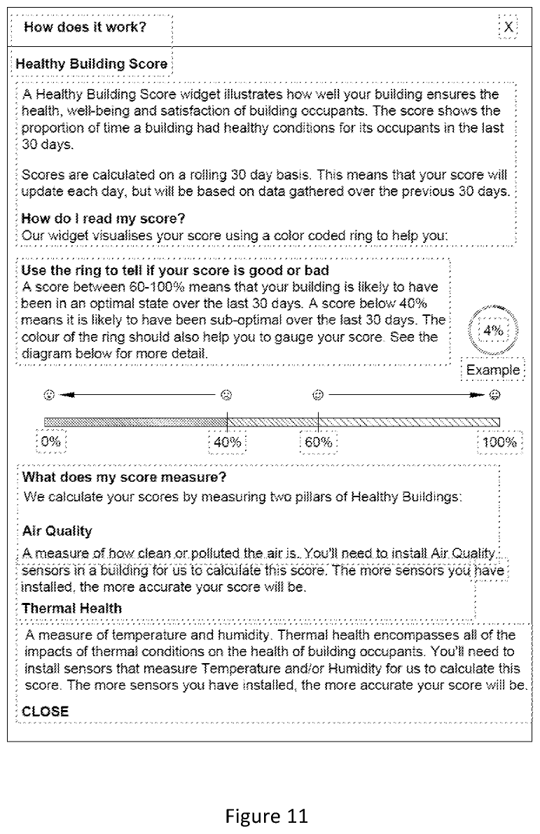

FIG. 11 shows the Healthy Building Score pop up window that explains to users how the Healthy Building Score system works.

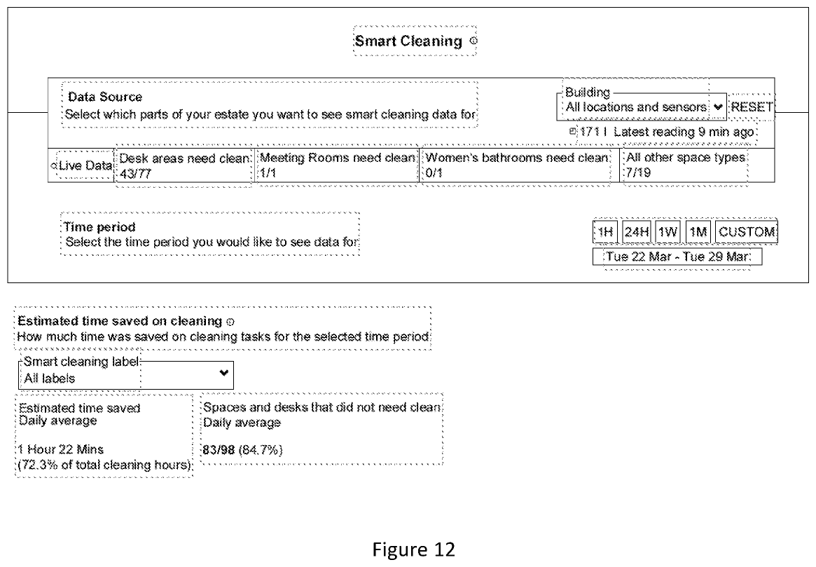

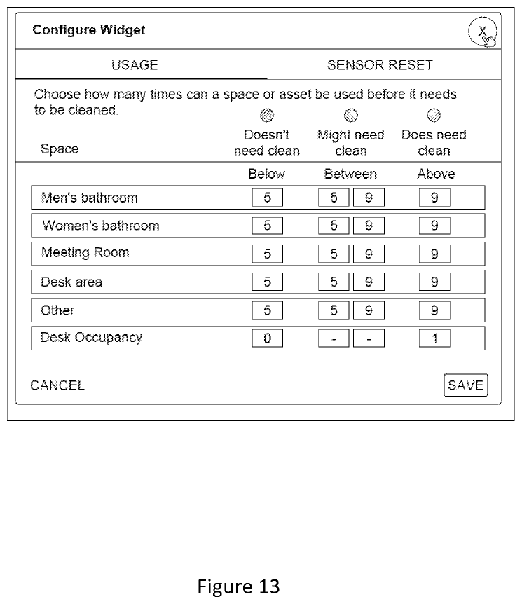

FIGS. 12 and 13 shows the cleaning widget configuration window: it enables the user to define how many times a specific space (e.g. toilet, desk, room etc) can be used (e.g. as detected by IR-based proximity sensors or other people counting systems, including people counting systems that indirectly infer the presence of a person, just as the desk occupancy ‘sensor’ is in fact a temperature sensor that infers the presence of a person at a desk by the rise in air temperature detected by an air temperature sensor placed under the desk). This sort of intelligent cleaning can eliminate unnecessary cleaning, and ensure that cleaning does happen when it is required.

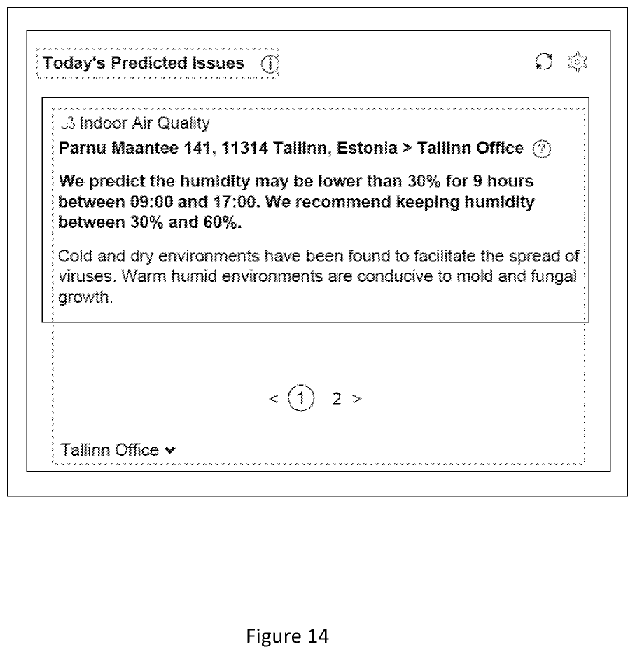

FIG. 14 shows the ‘Today's Predicted Issues” widget: the Infogrid system automatically analyses various sensor outputs and compares these to predefined thresholds, generating an automatic alert if a threshold is likely to be exceeded. In FIG. 14, we see an alert that in the Tallinn office, the humidity is predicted to be lower than 30% and the system automatically suggests remedial action.

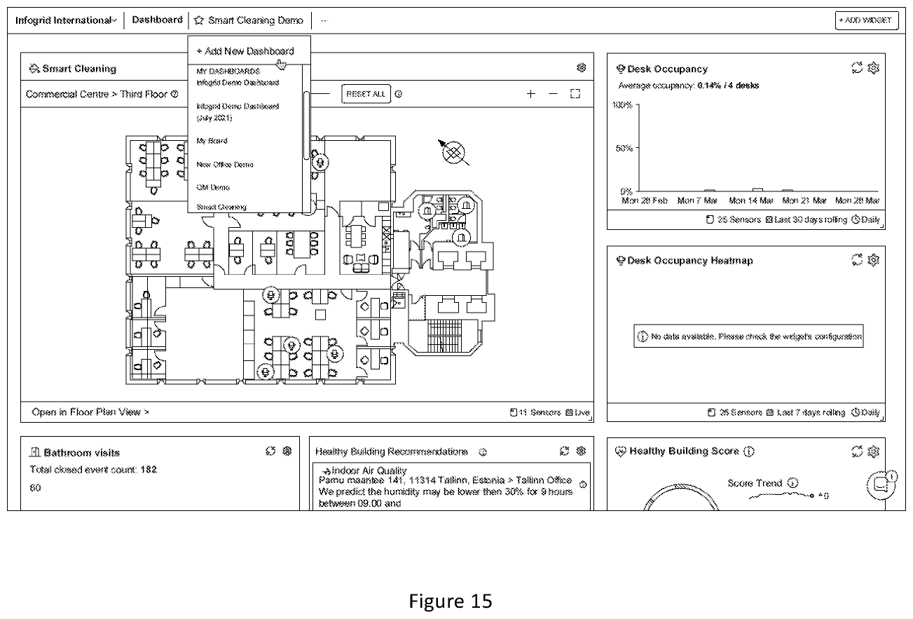

FIG. 15 returns us to the dashboard again, showing the floor plan widget, the desk occupancy widget, the desk occupancy heatmap widget, and partial views of a bathroom visits widget, a healthy buildings recommendations widget, and the healthy building score widget.

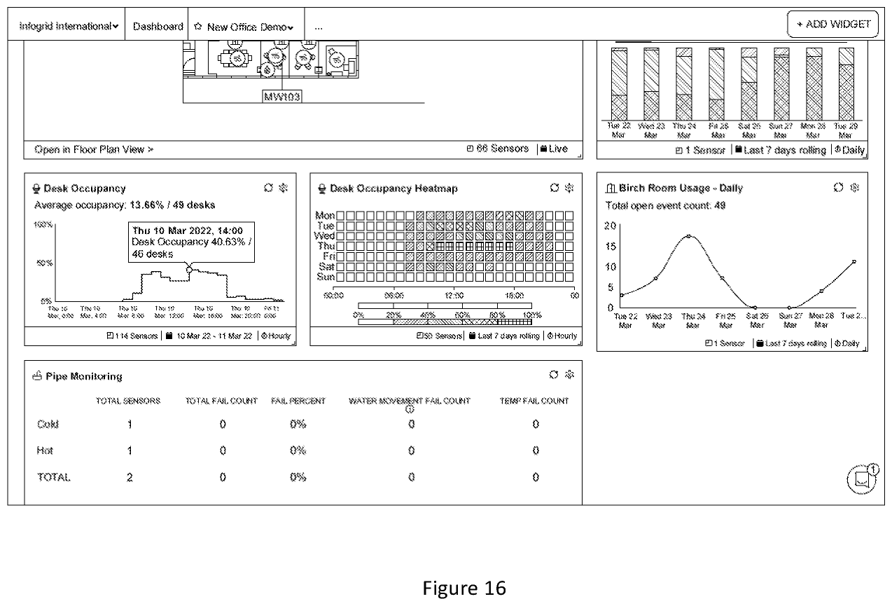

FIG. 16 includes the desk occupancy widget, the desk occupancy heatmap widget, the ‘Birch’ room usage widget and the pipe monitoring widget. It shows where each sensor is placed (e.g. on a cold pipe, or a hot pipe, or a blended pipe, or the flow or return sides of a calorifier. It shows how many pipes are likely to fail the standard L8 test for legionella compliance, and breaks down the failure mode according to whether the failure is through insufficient water movement and/or the water sitting in the danger zone for legionella for too long.

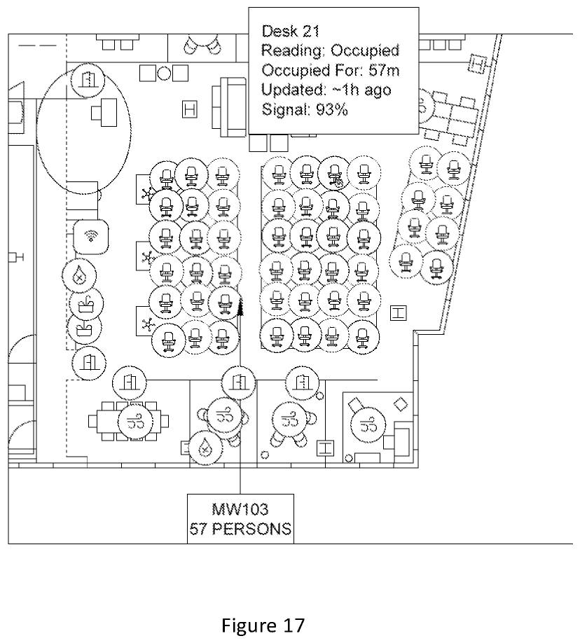

FIG. 17 focusses on the floor plan widget, showing how a user can select a specific sensor (shown as circles; the chair in a circle icon shows desk occupancy; the air blowing in a circle is air quality; the tap in a circle is pipe monitoring etc). In this case, the virtual desk occupancy sensor for a specific desk is selected, and its related data is displayed: in this case, that desk 21 has been occupied for approximately 57 minutes, based on a reading taken about 1 hour ago, with a wireless signals strength to the IoT air temperature sensor at 93%.

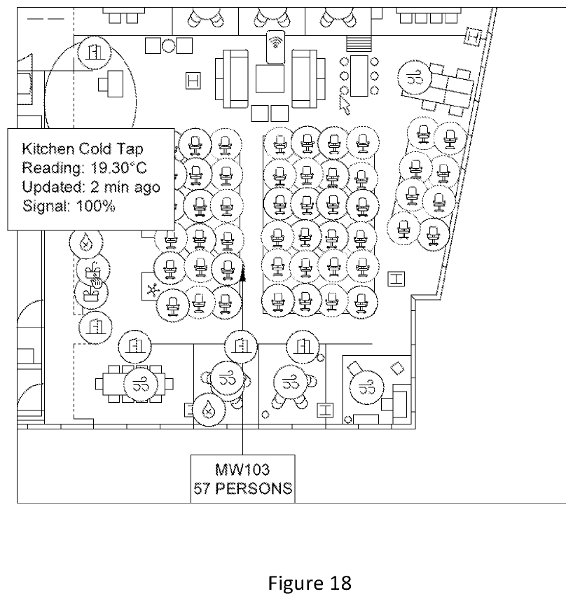

FIG. 18 shows the tap in a circle icon for pipe monitoring being selected: in this case, the user interface displays the data that the kitchen tap pipe is reading 19.30 C and that reading was updated 2 minutes ago, at 100% signal strength.

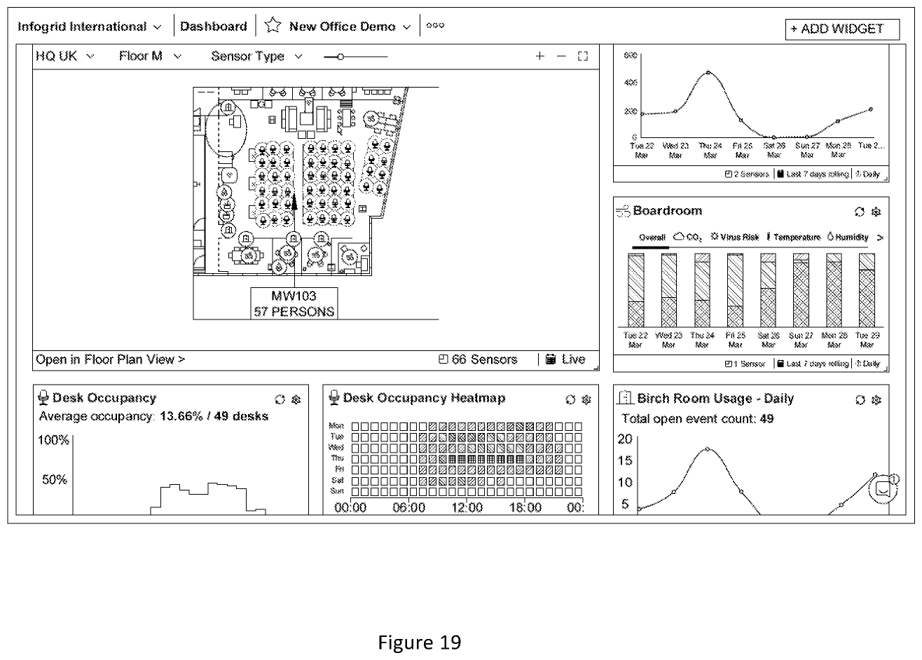

FIG. 19 shows how the dashboard appears on a typical desktop PC display, including multiple widgets, giving an at-a-glance view of various widgets.

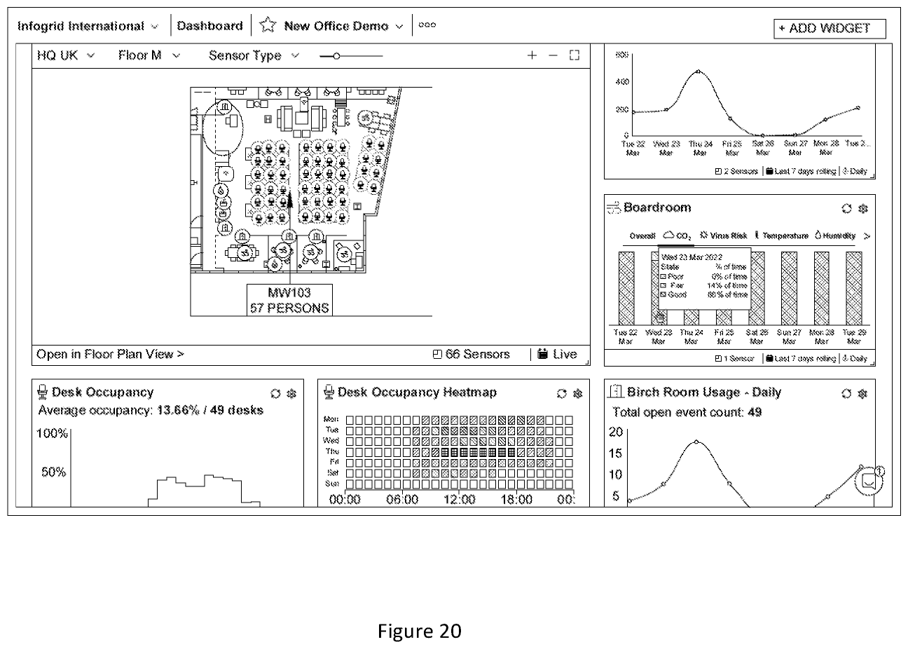

The user can scroll down to expose further widgets. In this case, as shown in FIG. 20, the user wants to know more about the air quality in the Boardroom on Weds 23^{rd} march: the pop-up window shows that the air quality was rated ‘poor’ for 0%, ‘fair’ for 14% and ‘good’ for 86% of the time.

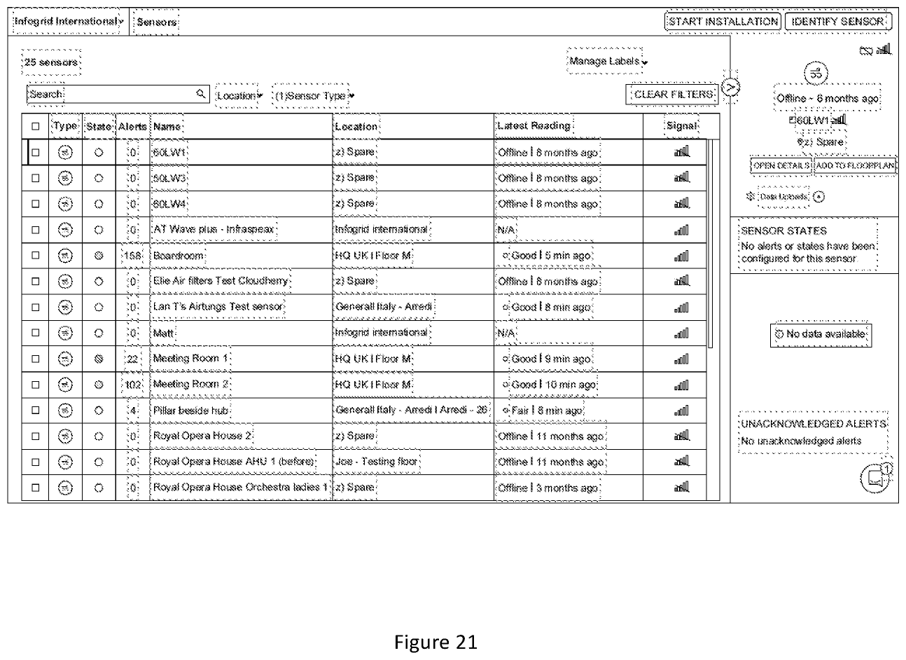

FIG. 21 shows how the system can provide a complete view of all sensors, including type, location, latest reading, signal strength and numbers of alerts for each sensor. For each sensor, the user can also call up a detailed log of all data, time indexed.

### APPENDIX 1: A USER GUIDE TO THE INFOGRID SYSTEM

This Appendix 1 covers the following areas; it forms part of a practical user guide for the Infogrid system:
Section 1: How to set up your folder structure:
Section 2: How to configure a device in the Web App using the Installation Flow
Section 3: Mapping the sensors onto your floor plan
Section 4: Installing a Leak Detection Sensor
Section 5: Installing your Desk Occupancy Sensors
Section 6: Installing Touch Sensors for Feedback Panels
Section 7: How to install Door Proximity sensors
Section 8: Installing a Cloud Connector
Section 9: Installing a Pipe Monitoring Sensor
Section 10: Installing your Air Quality Hub
Section 11: Installing an Air Quality Sensor
Section 12: Dynamic or Smart Cleaning
Section 13: Pipe Monitoring (inc. Legionella)
Section 14: Monitoring Indoor Air Quality
Section 15: Door Monitoring Widget to monitor washroom use
Section 16: Dashboards: Desk Occupancy
Section 17: Indoor Air Quality Dashboard
Section 18: Creating alerts: How do you set up a new alert? How do you change or remove existing alerts?

Section 1: How to set up your folder structure: Detailed guidance on creating a structure in the Web App that allows you to determine where your sensors are located, and enriches the data.

Within the Web Application you need a way to organise all the devices (i.e. sensors and ‘Cloud Connectors’ etc.) that you will be installing. It is important that you do this prior to physically installing your devices. You will need to decide on both the structure you want to use, and the naming convention by which you want to name things. For both of these, it is important you do this logically, and name the folders in a way that can easily be interpreted by someone who hasn't been involved in setting up the structure. For example, when one of the sensors triggers an alert, a remote engineer who has never been to that building, might be the one that gets the email to take action. In the email it will show them the sensor name, and the breadcrumb trail of folders that the sensor is contained within.

### Creating the Folder Structure

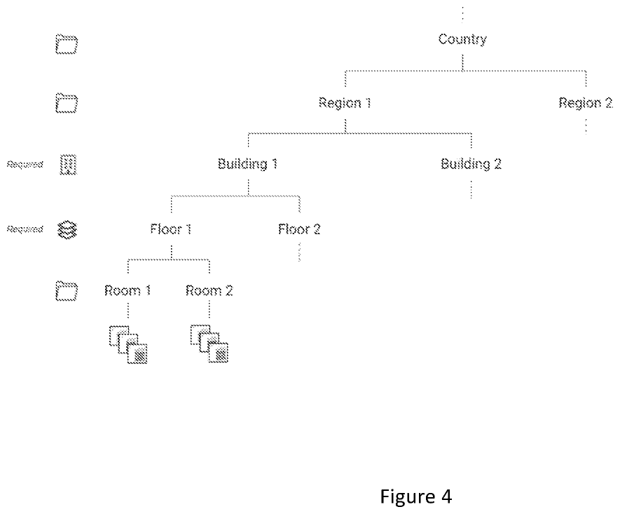

Like common document storage applications, you have the ability to create folders in the Web Application. Some of these folders can remain flexible folders, and some of the folders are required to be associated with a Building or Floor. This helps you utilise some of our other features such as Floor Plans and the Installation Flow. A Floor Plan for example, will be uploaded for a Floor. You will see a folder with the name of your organisation. you should set up the folder structure within this folder. We strongly recommend that you structure the folders geographically for the entire hierarchy, mirroring locations in the real world. An example is shown in FIG. 4. Note three points from the FIG. 4 diagram:
1. While the top of the hierarchy can be somewhat flexible, Building and Floor folders are required to install your sensors in.
2. You have the option of creating Rooms within the Floors. Rooms should not have any subfolders. Try using the sensor name, and labelling to identify the location of the sensors within a Room.
3. Sensors should typically be installed into the lowest level folder. In this case, the rooms.

### Set Up Your Folder Structure

To set up your folder structure you need to do two things:
1. Create the folder structure.
2. Convert the Building and Floor folders into Buildings and Floors.

Firstly, create your folder structure in the Folders section of the Web App.
1. Go to the Folders section.
2. Click Create Folder, and name the folder.

Then you need to tell the Web Application which of these folders are the Buildings and Floors. Go the ‘Floor Plan’ section in the Web Application and follow the instructions below:
1. Click Create a new building at the top of the page.
2. Select the folder that you want to convert to a building. At the moment you can only do this one at a time.
3. Add the address of the building.
4. Choose the sub folders that you want to convert to floors.
5. Repeat for other buildings.

Once you have done this, you will see in the Folders section that the icon next to the Building and Floor folders have changed. Note that you can also create Buildings and Floors from the Floor Plan section of the Web Application, which will create these, already configured, folders in the Folders section. You are now ready to start installing sensors using the installation flow, and adding floor plans to each floor so that you can mark where you have put your sensors.

### Section 2: How to Configure a Device in the Web App Using the Installation Flow

When installing a sensor device you need to both do the physical installation of the device, and also configure that device in the Infogrid Web App (i.e. move a sensor to a folder location, name the sensor etc.). This section covers how to configure the device in the Web App in 3 or 4 clicks. In the Web App there should already be a folder structure set up in line with the locations that the devices will be installed. There should be a folder for the Building and Floor (and, if you have created them, Room) that you will be installing the device.

What you will need: A phone or tablet with a camera and internet connection: The device (sensor, cloud connector etc.) you want to install: An understanding of your company's naming convention for devices, and labelling methodology. The building and floor (and room/area) you want to install the device to must be configured using the Floor Plan feature in the Web App (NB this is not just having the folders created. You also need to have configured the relevant folders as buildings/floors)

### How to Install and Configure a Device

1. Go to the Sensors page in the Web App
2. Click Start Installation

You will then be taken into a separate screen to configure the device in 3 or 4 clicks:
1. Identify the device
2. Check the device is connected to the cloud
3. Configure the device
4. Install the physical device

### Identify the Device

Every device can be identified 2 ways:
Scanning the QR code on the device using the camera on your phone or tablet
Manually typing in a serial number, or touching the device, depending on device type

### Check the Device is Connected to the Cloud

Once identified, you will need to go to the location you want to install the device to test its connection.

### Configure the Device

### 1—Building Name

Select the building you are installing the device in
Once you have installed your first device this will be prepopulated with the building that you last installed the device in
Make sure you change this when you move to a different building to install a device

### 2—Floor Name

Select the floor you are installing the device on
Once you have installed your first device this will be prepopulated with the floor that you last installed the device in
Make sure you change this when you move to a different floor to install a device

### 3—Room Name

This field will only appear if you have created folders for rooms on each floor.
Select the room you are installing the device in
Once you have installed your first device this will be prepopulated with the room that you last installed the device in
Make sure you change this when you move to a different room to install a device

### 4—Device Name

Type the name of the device, following your company's naming convention
This is where you will need to name the device so that it can be located by an engineer responding to alerts

### 5—Select Pipe Type

This field will only be displayed when configuring a sensor that will monitor legionella in pipes (see Appendix 2). It will not appear for all other devices. It is very important this is done correctly as it affects the compliance reporting, therefore is a required field.
Select the pipe type you have installed the sensor to; Hot, Hot—POU Heater, Cold, Calorifier Flow, Calorifier Return etc.
This will add a tag to the sensor name when viewing it in the Web App (shown below), so it will be easy for others to identify

If installing on a hot tap, it is important to note whether that tap is being fed by a Point of Use (POU)

Water Heater. If it is you will need to select Hot—POU Heater. If it is not, you select Hot.

### 6—Temperature Offset

This field will only be displayed when configuring a sensor that will monitor legionella in pipes. It will not appear for all other devices.
When monitoring pipes, the sensor is installed on the outside of a pipe, and therefore measures the temperature of the pipe, not the water
An offset can be applied here to ensure you are accounting for this, and therefore reporting the temperature of the water in the Web App
   7—Add label
Add labels to the device following your company guidance
Your company should have created a list of labels prior to you installing devices, and specified how they would like you to use these

### Install the Physical Device

Follow instructions to install the device. These will vary by the device you are installing.

Section 3: Mapping the Sensors onto Your Floor Plan

The final step to installing the sensors is ensuring they are mapped onto your floor plan correctly. The floor plan should already be uploaded to your account. To find your floor plan, go to the floors section, and select the building and floor you are installing on. The sensors you have installed following the steps in the previous sections will show on the right-hand side of your floor plan. From here, you will be able to drag and drop them to the correct location. If you have dropped the sensor in the wrong location, simply click on the sensor on the floor plan, and press “move sensor”. This will allow you to pick it up and drag it to the appropriate location.

### Section 4: Installing a Leak Detection Sensor

Leak Detection sensors can be used to detect leaks from pipes or other sources. This allows you to be immediately by alerts if a leak is detected, safeguard valuable equipment and machinery against water damage, and reduce water waste across your estate. Importantly, before installing your sensors you should have a Cloud Connector installed in the area that you are installing your sensors so you can check the signal of the sensors as you install them. For leak detection you will be using a Wireless Water Detector sensor. The sensor detects if there is water in contact with the sensor or not. The moment water comes in contact with the sensor it wirelessly transmits the results to the cloud through Cloud Connectors where it can be seen in the Infogrid platform or exported to other services via developer APIs.

### How to Install

Simple 4-step process:
1. Set up the sensor in the range extender
2. Configure the sensor in the Web App
3. Attach the textile add on to the range extender and secure this in place with the Clip
4. Install the sensor

### Set Up the Textile Add-on on the Floor/Surface:

The Water Detector Range Extender Textile Add-on is used to increase the sensitivity of the Wireless Water Detector. The add-on enables the Water Detector to detect even small amounts of water in contact with the strip anywhere along its length.
Improves the sensitivity of the Water Detector
Contains adhesive for attachment to surfaces
Allows detection of water over a larger area compared with the Water Detector Range Extender

High humidity: Use only in non-condensing environments since it will react to high humidity. Typical use: Environments where water is normally never present.

### Physically Install the Sensor:

Once you have set up the sensors with the range extender and the textile add-on, as well as configured them on the Infogrid Web App, you are ready to go ahead with the physical installation.

### Section 5: Installing Your Desk Occupancy Sensors

What Will You Need for this Installation?
A phone or tablet with a camera and access to the internet
   For IOS devices: Chrome, Safari or Firefox browsers are recommended
   For Android devices: Firefox browsers is recommended
Temperature Sensors

### Installing Your Cloud Connector

The first step as part of the installation is to install your Cloud Connector.

### How to Configure Desk Occupancy Sensors in the Infogrid Web App

1. Log into the Web App and use the menu to navigate to the ‘Sensors’ page. When you are on the sensors page, tap the START INSTALLATION button at the top (right) of the screen.
2. Scan the QR code of the sensor
3. Configure the device in the web app (below) and save

### How to Physically Install Your Desk Occupancy Sensors

1. Peel off the sticky back and place the sensor under the desk (face down). You will need 1 sensor per desk.
   Tip: Aim to place your sensor under the desk, in the middle, directly above where someone's lap would be should they sit at the desk. Position your sensor towards the edge of the desk.
2. Press down for 2-3 seconds to ensure the sensor is firmly attached to the desk,

### Section 6: Installing Touch Sensors for Feedback Panels

What you need:
1. Cloud Connector (CCON)
POE injector plug adapters & ethernet cable included in box
2. Touch sensor
3. Feedback panel
Step 1: Place the Cloud Connector (CCON) in a location central to where the touch sensors will be installed. Plug one end of the ethernet cable into the ‘Data+Power’ or ‘In’ port on the POE injector, and the other into the CCON. Plug in the CCON and make sure you can see the white cloud symbol with signal strength dots. NB—you will not necessarily have to repeat this step, if there is another CCON nearby
Step 2:
   On the Infogrid WebApp navigate to sensors on the left hand side.
   You will see two options at the top right, click on start installation
   Click Manually identify devices and click on ‘Other device.’
   Press and hold on the touch sensor for 3 seconds.
   Click again and you will get a pop up window showing the sensor status, if the sensor shows offline then you can still continue the offline installation.
   Press next and then fill in the details as shown in step 3.
Step 3:
Configure the device in the web app
Attach the sensors to the panel.
Peel off the sticky back and place the sensor on the “place sensor here” square, next to the appropriate feedback section. E.g. if you named the Sensor “Good”, place next to the good feedback area.

### Section 7: How to Install Door Proximity Sensors

What you need:
1—Cloud Connector (CCON)
2—Proximity sensor

1 per door: Place the Cloud Connector (CCON) in a location central to the where the Desk Occupancy sensors will be installed. Plug one end of the ethernet cable into the ‘Data+Power’ or ‘In’ port on the POE injector, and the other into the CCON. Plug in the CCON. And make sure you can see the white cloud symbol with signal strength dots. Configure the Sensor in the Infogrid web app. Install the CCON high on a wall, out of busy spaces and not on a metal surface. For example, a good location would be in a riser.

### Section 8: Installing a Cloud Connector

### Step 1:

Log into the Web App and use the menu to navigate to the Sensors page. When you are on the sensors page, tap the INSTALL button at the top of the screen

### Step 2:

Scan the QR code of the sensor/CCON
Attach the sensor to the door.
Identify the best place to place the sensor on the door, or door frame. When closing, the door should cover the sensor, and be less than 6 mm away from it. Ensure there is enough space for the door to close without damaging the sensor.
Peel off the sticky back and place the sensor on the door or door frame or door

A Cloud Connector is the device that collects data from all wireless sensors and sends data to the cloud, so it can be viewed in the Web App. A cloud connector can collect data from sensors that are within ˜75 m of it in an open space, falling to 25-40 m in a hospital ward. Like Wi-Fi, this varies based on thickness of walls and floors between sensors and Cloud Connector, and any other obstacles. A single Cloud Connector can host up to 30,000 sensors at once, as long as they are within range. You will need a Cloud Connector installed before you are able to configure and install cloud-based sensors.

What Will You Need for this Installation?
A phone or tablet with a camera and access to the internet
Hardware (Cloud connector, screws, ethernet cables, PoE-injector plug adaptors
Pen and sticker (optional, for adding label to plug saying “Do not remove”)

### How to Install

Simple 2 step process:
1. Configure the Cloud Connector in the Web App
2. Install the Cloud Connector

### Configure the Cloud Connector in the Web App

Configure the Cloud Connector in the Web App. The QR code needed to identify the device is on the back of the Cloud Connector. If identifying the Cloud Connector manually (via touch), it will need to be plugged in and online. Also make sure you have removed the plastic film on the front of the Cloud Connector for the touches to register.

### Install the Cloud Connector

### Installation Tips

Installing high on a wall, in a riser or in the ceiling will avoid installing in public spaces with high footfall where they can be easily knocked
Avoid placing it on metallic surfaces, in metal cupboards etc. as this hinders connectivity and range
Installing in the middle of a room will give better coverage
For a basement installation, the Cloud Connector may work from the ground floor (connecting to sensor in the basement), but if not you'll need a Data over Ethernet access point in the basement
1. Plug one end of the Ethernet cable into the port named either ‘Data+Power’ or ‘Out’ on the POE injector, and the other end into the Cloud Connector.
2. Take the Cloud Connector to the installation location and plug the POE injector into the wall.
3. Check the Cloud Connector is online by looking for the white cloud symbol (see below). The dots beneath the cloud symbol indicate the signal strength. It may take some time to come online and you may see the red cloud prior to seeing the white one. If the red cloud remains for some time, see to troubleshooting.
4. Install the sensor high on the wall using the screws or sticky pad provided. Screws are recommended for permanent installations.

### Section 9: Installing a Pipe Monitoring Sensor

Pipe Monitoring sensors can be used to monitor temperature in pipes. This can be used to determine whether taps need to be flushed, or minimise the risk of Legionella (See Appendix 2).

Importantly, before installing your sensors you should have a Cloud Connector installed in the area that you are installing your sensors so you can check the signal of the sensors as you install them. For pipe monitoring you will be using a Wireless Temperature EN12830 sensor, a surface range extender and a thermal heating pad.

As well as the hardware to install above, you will also find it useful to have:
Knowledge of how your company want you to set temperature offsets
A probe to measure the temperature of running water (required for offsetting)

### How to Install

Simple 4 step process:
1. Set up the sensor in the range extender
2. Configure the sensor in the Web App
3. Install the sensor
4. Set a temperature offset

Set up the sensor in the range extender: NB it is important you do this before configuring the sensor as when configuring the sensor it displays the signal strength. Only once you set up the sensor in the range extender will you get a true reading of signal strength. If you do not do it the signal will appear weaker than it would be if set up in the range extender. Pick up the sensor, turn it over, peel off the brown sticky tape, place into the Surface Range Extender (face up), ensuring that the orange dot on the sensor aligns with the black dot in the mount (this is very important). Press down firmly for 2-3 seconds.

Configure the sensor in the Web App: make sure you select the pipe type that you are installing the sensor on. The QR code needed to identify the device is on the front of the sensor.

### Install the Sensor

1. Place green/grey thermal conductor pad over top of sensor, ensuring you remove the thin protective plastic film on both sides.
2. Pass cable-tie through slots on reverse of Surface Range Extender.
3. You may need to cut away any lagging to ensure the thermal conductive pad is touching the pipe.
4. When attaching to the pipe, place the sensor/thermal conductive pad face down against the pipe and pull cable tie as tight as possible around the pipe. The thermal conductive pad should ‘squidge’ a little and there should be no air gap. Importantly, install the sensor as close to the tap outlet as possible for the best results.

Set a temperature offset: Setting an offset will set a permanent temperature change to all data.

### Recommended Installation Locations

These are the sensor locations we recommend, subject to your Scheme of Control:
1. Cold Water Supply (pre-storage tank)
2. Cold Water Supply (post-storage tank)
3. Boosted Cold Water Supply (post)
4. Calorifier (pre or supply)—use ‘Industrial Temperature’ sensors where possible
5. Calorifier (post or flow)—use ‘Industrial Temperature’ sensors where possible
6. Calorifier (return)—use ‘Industrial Temperature’ sensors where possible
7. Boiler (pre on cold water supply)
8. Boiler (post on hot water outlet)—use ‘Industrial Temperature’ sensors where possible
9. Cold taps—pre-TMV
10. Hot taps—pre-TMV
11. Blended taps—optional if you have installed pre-TMV as above, but
12. Taps fed by a point of use heater (optional pre+post)
13. Water coolers—on the thin plastic pipes that lead to the cooler (make sure the pipe runs down the middle of the thermal pad covering the installed sensor)

Outlet specific guidance: When installing on outlets, make sure you think about 3 things:
1. Install as close to the outlet as possible. This is especially important when installing on Point of Use water heaters as the heat from the heater can affect the sensor's readings.
2. Install on a pipe that only leads to a single outlet, not one that feeds multiple outlets. We need to know when each outlet is flushed.
3. Make sure the cable tie is firmly installed so the sensor cannot slip

Temperature Offsets for Pipe Monitoring: When you install a pipe monitoring sensor, you are installing it on the outside of a pipe and therefore you are measuring the temperature of the pipe and not the water itself. For compliance reasons, it is important the sensor monitors the temperature of the water. A temperature offset is designed to ensure you are monitoring the temperature of the water in the pipe, rather than the temperature of the pipe itself. For example, the sensor might record the temperature of a pipe as 40° C. The water in the pipe might be 42° C. (as measured by a probe at the point of installation). Adding an offset of +2° C. means the Web App will always show a reading 2° C. above the temperature the sensor is measuring, which will be a more accurate reading of the water in the pipe, rather than the pipe itself.

### What Will You Need to Set Offset Manually

Pipe monitoring sensor already installed on the pipe
An accurately calibrated probe for measuring water temperature
Something you are able to time 60 seconds on (e.g. stopwatch, timer)
To be logged into the Infogrid Web App

How to find the temperature offset: The aim of the steps below is to calculate the difference between the actual temperature of the water (using a probe), and the sensor's reading in the Web App. You will then record the difference in the Web App, which will permanently offset the temperature that sensor reads to give you the temperature of the water.

The pipe monitoring sensors take readings every 5 minutes, which can be seen in the Web App. Therefore, in order to calibrate accurately, you need to ensure you take a reading with the probe at the same time as the sensor takes a reading.

### Step 1—Take Temperature Readings

1. Find the sensor in the web application.
2. When the latest reading time value turns to ‘4 mins ago’, turn the tap on and start measuring the temperature of the water with the probe. This allows the probe to get to the temperature before the sensor takes the reading. Make sure the probe head is directly under the flow of water.
3. When the latest reading time field turns to ‘5 mins ago’, continue to measure the temperature of the water, and start a timer for 60 seconds.
4. When your timer reaches 60 seconds, note down the temperature reading that the probe is displaying. By now the reading should be steady or with minor fluctuations. If it is continuing to rise and drop, this will not be an accurate representation of the temperature and you may need to start again and start measuring the water temperature with the probe prior to ‘4 mins ago’ mark.
5. The latest reading time field should now show that the reading has been taken recently. Record the temperature reading shown, which will stay the same for the next 5 mins until the sensor takes the reading again.
6. Now calculate the difference between the temperature reading you got from the probe and from the sensor. This should be no more than +−5 deg.

### Apply Offset in Web App

1. Click on the sensor in the Web App.
2. Click the Configuration and Details tab.
3. Under Sensor Configuration, click the configuration icon and type in the difference between the temperature of the pipe and the temperature of the water. Make sure to get the +/− sign correct.

### Examples of Temperature Ranges Use for Offsets

Note that the table below only serves as rough guidance of what temperature offsets you′d expect to find when measuring required temperature offsets with a probe, and therefore cannot be relied upon on during installation to set offsets.

| | Hot pipe | Cold pipe |
|---|---|---|
| Copper pipe | Between 0 and 2° C. | Between −2 and −3° C. |
| Plastic pipe | Between 3 and 6° C. | Between −3 and −6° C. |
| Steel pipe | Between 2 and 3° C. | Between −3 and −4° C. |

### Section 10: Installing Your Air Quality Hub

A Hub is the device that collects data from all Air Quality and other sensors and sends data to the cloud, so it can be viewed in the Web App. A Hub can collect data from sensors that are within ˜100 m of it in an open space. Like Wi-Fi, this varies based on thickness of walls and floors between the sensor and the Hub, and any other obstacles. It can connect to sensors ˜4 floors away from the Hub. A single Hub can host multiple Airthings sensors at once, as long as they are within range. You will need to install the Hub, as detailed below, before you install any Air Quality etc. sensors.

What Will You Need for this Installation?
A phone or tablet with a camera and internet connection
Hardware: Air quality sensor (e.g. Airthings sensor); charger, SIM card, ethernet cable
Pen and sticker (optional, for adding label to plug saying “Do not remove”)

### How to Install

Simple 2 step process:
1. Configure the Hub in the Web App
2. Install the Hub

Configure the Hub in the Web App. Remove the plastic cover on the back of the Hub to reveal the QR code needed to identify the device using your camera, and Serial Number if needing to identify the device manually.

Install the Hub: The Hub can be connected to the cloud in two ways; via cellular or ethernet. We recommend trying to install using cellular first. If you can't get a cellular connection (shown by the green cloud symbol on the Hub), use the ethernet method.

### Section 11: Installing an Air Quality Sensor

Air Quality sensors can be used to monitor a number of air quality variables such as Radon, Volatile Organic Compounds (VOCs), air pressure, humidity, light, temperature and carbon dioxide. This sensor will give you the information you need to be able to make informed, positive changes to a building or space, in order to improve health and wellbeing or building efficiency.

Before installing your sensors, you should already have an Air Quality Hub installed in the area that you are installing your sensors so that you can check the signal of the sensors as you install them. To measure air quality you will be using e.g. an Airthings Wave Plus sensor.

What Will You Need for this Installation?
A phone or tablet with a camera and internet connection
Hardware: Airthings Wave Plus, double sided tape, screw.

### How to Install

Simple 3 step process:
1. Configure the sensor in the Web App
2. Install the sensor
3. Check the sensor is online

Configure the Wave Plus in the Web App. Remove the magnetic disk on the back of the sensor to reveal the QR code needed to identify the device using your camera, and Serial Number if needing to identify the device manually.

### Install the Sensor: Installation Tips

Recommended height: 150-170 cm above the floor (about head height)
Install at least 1 m away from exterior walls, doors, air supply/exhausts, mechanical fans, heaters or any other significant source of heat or cold.
Do not mount on the ceiling
Use the double-sided tape included with the sensor for installations onto most walls. For installations onto wood, fabric uneven surfaces or to industrial equipment or elevators, we recommend using a screw to mount the sensor.
1. Remove the circular disk from the back of the sensor.
2. Using the double sided sticky tape (provided), or screws for installations onto trickier surfaces (see tips above), stick the circular disk to the desired location.
3. Place the sensor back onto the circular disk.

Check the sensor is online: A Smartlink will be established between a powered-up Wave device and a nearby powered-up Hub. It can take up to 12 h to establish such Smartlink.

### Section 12: Dynamic or Smart Cleaning

### Before You Start

An Infogrid dashboard should already be set up for your account and site location.
The Hub and Cloud Connectors are required in order to connect all of the sensors to the cloud.

What is Dynamic Cleaning? Dynamic Cleaning is a technical solution for large buildings and estates that uses discrete wireless sensors, cloud storage and the Infogrid platform to provide reports and alerting about cleaning tasks. It enables teams to target cleaning efforts to when and where they are needed most—giving cleaners and supervisors more time to focus on what they do best.

Discrete wireless sensors: The world's smallest sensors take seconds to install, send data every 5 or 15 minutes and have a battery life of up to 15 years.

Cloud storage: Sensor data is received by cloud connectors over radio frequency and then sent to the cloud via secure cellular networks.

Infogrid platform: Use your mobile or computer's web browser to visualize data and get powerful insights. Or send data to your systems with our API.

Reports and alerting: Notify your team to urgent matters with customizable SMS and email alerts. Export and share your data with one-click reporting.

### The Sensors

Dynamic Cleaning uses 4 types of sensor to gather information about a building and how it is being used. This data is then used to determine whether a room, space or asset needs to be cleaned. The step-by-step section of this document will help you install each sensor type quickly and easily.

| | | How frequently | |
|---|---|---|---|
| | What does the | does it give | |
| Sensor type | sensor measure? | measurements? | What is the data used for? |
| Desk | Detects if someone | Every 5 | Desk occupancy to |
| Occupancy | is sitting at a | minutes | determine which desks |
| | desk using shifts | | need cleaning |
| | in ambient | | |
| | temperature | | |
| Touch | Press button that | Every time it | Customer feedback. |
| | detects when | is pressed | Are bathroom users happy, |
| | pushed | | neutral, or unhappy |
| | | | with the cleaning? |
| Door | Detects objects | Every time it | Understand patterns of |
| Proximity | removed or | detects | bathroom and meeting |
| | placed in front of | movement in | room occupancy, and to |
| | sensor | front of it | set alerts if a bathroom |
| | | | is used frequently |
| Air | Temperature, | Every 5 | Monitoring virus risk |
| Quality | Humidity, Air | minutes | through CO2, Temperature |
| | pressure, CO2, | | and Humidity levels |
| | TVOC, Light and | | |
| | Virus Risk | | |

### Where to Install Sensors

Each Dynamic Cleaning sensor is installed in a different location in your building, based on the data it gathers. The table below shows where each sensor should be installed and some useful tips for how to install it. The step-by-step guide on the following pages will detail when each sensor should be installed in the correct location.

| Sensor type | Location | Installation tips |
|---|---|---|
| Desk | Under the desk, in the middle, | Think about where someone's |
| Occupancy | directly above where someone's lap | lap would be if they were to sit |
| | would be should they sit at the desk. | at the desk, and place there |
| | A few inches away from the front. | |
| Touch | Stuck onto the feedback panels. | Place the feedback panel |
| | Feedback panels to be mounted on the | somewhere visible to encourage |
| | wall near the bathroom exit | feedback |
| Door | To be deployed on main access door | Make sure there is a few mm of |
| Proximity | entrances/exits on the door frame. | clearance between the door and |
| | | the sensor so the door doesn't |
| | | damage the sensor |
| Air | Mounted on walls of the space you | Place the air quality sensor |
| Quality | want to monitor. One sensor will | around head height, as it's the |
| | monitor approximately 700 square | air people are breathing in |
| | feet of space | you want to monitor |

Section 13: Pipe Monitoring (Inc. Legionella)

This section is designed to help people involved in:
Setting up any pipe monitoring solution to improve Legionella monitoring and compliance (i.e. installation of devices and setting up alerts and dashboards)
Reviewing the data and alerts that you'll be receiving from these sensors once they've been installed.

Prior to you completing the two steps below that are specific to this use case, in the Infogrid Web App you need to have:
Created a structure in the Web App that allows you to determine where your sensors are located, and enriches the data
Upload floor plans (if they are being used)
Created new user accounts for installers and anyone else who will be interacting with the WebApp post installation (i.e. responding to alerts, reading dashboards etc.)

Install your Pipe Monitoring hardware: These steps should be carried out by those people who will be physically installing the devices on site (e.g. building engineers).
Login to the Infogrid Web App
Installing a Cloud Connector
Installing a Pipe Monitoring Sensor

Setting up alerts, building dashboards, interpreting data and generating reports: These steps should be carried out by anyone wanting to set up alerts or dashboards, interpret what the data from the sensors is telling them, or generate reports for compliance and record-keeping.
Set up pipe monitoring alerts in the Web App
Generating and interpreting pipe monitoring reports in the Web App
Building the dashboard to interpret pipe monitoring data in the Web App
Interpreting the sensor level information for pipe monitoring in the Web App

How to create, find & interpret pipe monitoring reports: Create a report for your pipe monitoring sensors, that shows your L8 compliance. Know where to find reports and what they are telling you

If you are using pipe monitoring sensors, you can create a special Pipe monitoring report.

This gives you an overview of the water temperature and water movement over a specific period of time, and provides a Pass or Fail result for each sensor based on standard measures detailed below.

### How to Create a Pipe Monitoring Report

1. Go to Folders section of the Web App
2. Select the Pipe Monitoring sensors that you want to run the report for. This can be done by filtering by sensor type and/or finding the sensors using the folder structure
3. Once selected, click on the down arrow to the right of Download selected and click on Pipe monitoring report.
4. Select the time period that you want the report to be generated over and click Start Generating. Your report will start running as shown by a green pop-up in the top right of your screen. NB The time period you select will be the time over which the algorithm will check if a water movement event has happened.
5. Clicking on the Open Report button in the pop-up, or navigating to the Reports section of the Web App using the right sidebar, will take you to the report. You will then be able to download this report as an Excel file.

### Where to Find Your Reports

All reports that have been generated within the last 90 days are stored in the Reports section of the Web App.

### Understanding Your Pipe Monitoring Report

The report will show you the maximum and minimum temperature reached for each sensor, within the chosen report period. Based on this and other sensor data, it will display 3 different Pass or Fail results:

### Temp Check

In order for a sensor to receive a Pass rating in the Temp check column, it must satisfy the following criteria:
Sensors with Hot sub-type need to reach 50° C. at least once within the chosen report period.
Sensors with Cold sub-type need to fall below 20° C. at least once within the chosen report period.
Sensors with Calorifier flow sub-type need to stay above 60° ° C. for the entire chosen report period.
Sensors with Calorifier return sub-type need to stay above 50° ° C. for the entire chosen report period.

Water moving check: A water moving event is defined by a rapid change in water temperature over a short period of time. A sensor will receive a Pass rating in the Water moving check column if there has been at least one water moving event in the time period that you chose to run the report over.

### Result

The final result is based on two conditions:
1. Whether the temp check has met the required temperature (based on the sensor type).
2. Whether there has been at least one water movement event.

An overall Pass in the Result column will only be given if both of these conditions have been met within the chosen report period.

### Section 14: Monitor Indoor Air Quality

This page is designed to help people involved in:
Setting up the Infogrid air quality solution (i.e. installation of devices and setting up alerts and dashboards)
Reviewing the data and alerts that you'll be receiving from these air quality sensors once they've been set up

### Steps

Prior to you completing the two steps below that are specific to this use case, in the Infogrid Web App you need to have:
Created a structure in the Web App that allows you to determine where your sensors are located, and enriches the data
Upload floor plans (if they are being used)
Created new user accounts for installers and anyone else who will be interacting with the WebApp post installation (i.e. responding to alerts, reading dashboards etc.)

### Install Your Air Quality Hardware

These steps should be carried out by those people who will be physically installing the devices on site (e.g. building engineers).
Login to the Infogrid Web app
Install the Airthings Hib
Install the Airthings Wave Plus

### Setting Up Alerts, Building Dashboards and Interpreting Data

These steps should be carried out by anyone wanting to set up alerts or dashboards, or interpret what the data from the sensors is telling them.
1. Set up air quality alerts in the Wb App
2. Building the dashboard to interpret air quality in the Web App
3. Interpreting indoor air quality information in the Web App

### Section 15: Door Monitoring Widget to Monitor Washroom Use

Dashboards allow you to have an overview of historic data for one or more sensors. You can create dashboards to visualise data from all of your sensors, should you wish, but also by building, floor, room, or any other grouping. To enable you to get started quickly and easily, we have created a dashboard library, where you can pick pre-built widgets that are specific to the use case you are employing.

Once you log in to Infogrid, click on the dashboard icon, on the top left, and then click “add new dashboard”. Get started by creating a Dashboard; Widgets are customised graphs that sit within your overall dashboard. Different widgets are relevant for different use cases. To create a new desk occupancy dashboard, click on the dashboard icon, on the top left, then click “Add New Dashboard”, and name it.

### 1. Add Widgets to Your Dashboard

You are now ready to add widgets to your dashboard using the “Add Widget” button. Door monitoring uses Proximity sensors to detect if a door has been opened or closed, so you will need to select Proximity Count from the list:

### 2. Select the Sensors Included in the Widget

Do you want to monitor a whole building, a floor or even a single sensor? Use this screen to select the sensors to include in the widget. If you select a building, all the sensors in all floors will be included; If you select a floor, only sensors in that floor will be included. The number in (brackets) denotes the number of proximity sensors in the displayed building or floor Click once to select (the line will turn blue) and again to de-select; You can also mix-and-match—in the example above, the widget will include all sensors in Estonia, along with the 6th floor in Capital Tower. When you have finished selecting your sensors, click Date Range.

### 3. Select the Period of the Readings

In this screen, you can decide if you want to exclude non working hours or weekends from the graphs, and select a time zone. Most importantly, you can determine the range of data the widget you will display. You can either display:
A fixed period (e.g. 1 January to 31 March, 31 May to 1 August)
A rolling period (e.g. Last week, last day, etc)

To do this, click the “Date range” field highlighted in red above.
To select a fixed date, click the relevant days in the calendar.
To select a rolling date, click the desired button at the bottom of the screen

To finish creating your widget, click “Display options”

### 4. Select the Data Frequency

You can set the data frequency of the widget by clicking the Data frequency field.

Each of these should help you identify a different kind of usage. Below you can find some examples of different insights that each frequency can provide.

Hourly—What are the times of peak use in this floor?

Daily—What are the days with greater footfall in my building?

Weekly/monthly—Is my estate more visited in summer or winter?

Once you select the data frequency and click Save, your widget is created and will appear in your dashboard.

NB: Avoid using hourly data with periods of time greater than 2 weeks—the graph might have too much information and that might obscure the insights.

### 5. Name Your Widget

The widget will be created with the name Proximity Count—hover your cursor over the name and click the pencil icon to rename it to something more memorable. Press Enter and your widget is created. How can I create a lot of widgets quickly? If you need to create a lot of similar widgets (e.g. one widget per floor of a building, you use the Duplicate option. Find the widget in your dashboard and click the ‘gear wheel’ icon: Clicking Duplicate will create a brand new Widget and will open the Sensor Configuration screen You just need to change the list of sensors, or the date, and click Save. A new widget has been created—now rename it, and you can move on to the next floor or building.

How many Widgets should I create? This will depend on how you want to visualise your data. Depending on how many sensors you have installed and how granular you want the data to be, you could create one widget per:
Individual sensor (if you want to monitor a particular door)
Floor
Building
Set of buildings (e.g. different campuses)

### Section 16: Dashboards: Desk Occupancy

Dashboards allow you to have an overview of historic data for one or more sensors. You can create dashboards to visualise data from all of your sensors, should you wish, but also by building, floor, room, or any other grouping. To enable you to get started quickly and easily, we have created a dashboard library, where you can pick pre-built widgets that are specific to the use case you are employing. Once you log in to Infogrid, click on the dashboard icon, on the top left, and then click “add new dashboard”.

### Get Started by Creating a Dashboard

Widgets are customised graphs that sit within your overall dashboard. Different widgets are relevant for different use cases. To create a new desk occupancy dashboard, click on the dashboard icon, on the top left, then click “Add New Dashboard”, and name it.

Add Widgets to your Dashboard

You are now ready to add widgets to your dashboard using the “Add Widget” button. There are three widgets that will help you set up a desk occupancy-specific dashboard:
Desk Occupancy
Floor Plan
Desk Occupancy Heatmap

### Desk Occupancy Widget

1. Select “Desk Occupancy” in the list of Widgets.
2. Select the sensors you would like to visualise.
3. Select a date range you would like to see the data for. This will automatically default to the last 7 days if you do not select a date range.
4. You can also select the date range on a rolling basis by clicking the “Date range” field. This is also where you could also choose to exclude weekends, or only select working hours, for example.
5. Select your preferred display options. This is where you can select the data frequency (hourly, daily, weekly or monthly), and whether you want to see the count of occupied desks.
6. Click Save—your dashboard is now displaying desk occupancy data.

### Floor Plan Widget

1. Ensure that you have uploaded a floor plan and allocated sensors onto the floor plan before creating the widget. You can check this by going to the “Floors” section on the left hand side menu.
2. Return to your dashboard, and select “Floor Plan” in the list of Widgets. Click Next”.
3. The floor plan widget is now created in the dashboard. You can now use the “Building” and “Floor” drop-downs to display the floor you need.
4. You can either create one widget for all floors and change the floor you want to view as needed, or you can create a widget for each floor you want to monitor.

### Desk Occupancy Heatmap Widget

1. Select “Desk Occupancy Heatmap” in the list of Widgets
2. Select the sensors you would like to visualise. You can be as granular as selecting one sensor, or room, floor, building, country, etc.
3. Select the date range you would like to see the data for.
4. Click “Save”. Your widget will now display the occupancy heatmap for the selected period, allowing you to understand what are the days and times at which occupancy is at its higher and lowest.

Building intelligence at scale; Once you have built your dashboard, you can start understanding occupancy trends in your building giving you the data at your fingertips to inform business decisions.

### Section 17: Indoor Air Quality Dashboard

Monitor CO2, VOCs, radon, humidity, light levels and air pressure to maintain optimal conditions and boost productivity without unnecessary use of energy. A set of thresholds (using commonly accepted air quality standards) is applied which provides an easily understood way of interpreting the different datasets. This can be seen through the red, amber, green colouring of the graph which will display a percentage of the time spent in “Good”, “Fair” or “Poor” conditions. To create an Indoor Air Quality dashboard, click on the dashboard icon, on the top left, then click “add new dashboard”, and name it.

There are two widgets that will help you set up an Air Quality specific dashboard:
Indoor Air Quality
Floor Plan

### Indoor Air Quality

1. Click add widget on the top right hand corner of the dashboard
2. Select Indoor Air Quality, and press next
3. Configure widget by first selecting the sensors you want to report on
4. Select the date range. This can either be a fixed date range, or on a rolling basis. The default will be the last 7 days. You can then choose whether you want the data inclusive of weekends or not, and select the hours you are interested in reporting on.
5. Click into display options, and select whether you want to see the data hourly, daily, weekly or monthly
6. Save

This will then create the above widget which will display an overall view of the Indoor Air Quality based on the data from the sensor(s) that you have selected (Co2, Virus risk, temp, humidity). The overall result is then broken down into 4 tabs on this widget where you can view the readings that have contributed to the overall result, by clicking into: CO2, Virus Risk, Temperature or Humidity.

### Floor Plan

1. Ensure that you have uploaded a floor plan and allocated sensors onto the floor plan before creating the widget. You can check this by going to the “floors” section on the left hand side menu.
2. Return to your dashboard, and select “Floor Plan” in the list of Widgets, then click next.
3. The floor plan widget shows all sensors available on your account. If you want to see a specific building, floor, or sensor type, go to the widget on the dashboard, and select the appropriate drop downs
4. Save

### Section 18: Creating Alerts: How do You Set Up a New Alert? how do You Change or Remove Existing Alerts?

To configure a new alert, you need to go to the Alerts overview section. You can do this by clicking on the exclamation mark icon on the left hand menu. Next, you need to click on the “Add new alert” at the top right. Once here, you'll be able to create a new alert.

Setting up an alert is as simple as giving it a name, choosing one of the configuration options, and editing the values, to create the alert condition you′d like.

Once you've decided on the condition, you need to decide which sensors to apply it to. You can select a folder of sensors (which will select all sensors in the folder) or one or more individual sensors. If any of the sensors meet the condition you've set, an alert will be triggered. You then need to decide who will be notified—and how they'll be notified. You can choose to send alert notifications by Email or SMS, and you can edit the messages we send when a notification is triggered. In the default template you'll see a number of values which will reflect the details of whichever sensor the alert is triggered for.

For SMS alerts, mobile numbers will need to be entered with an area codes (e.g., +447)

These include:
Sensor name: {{sensor_name}}
Sensor type: {{sensor_type}}
Sensor sub-type: {{sensor_sub_type}}
Sensor label(s): {{sensor_labels}}
Folder location: {{sensor_location}}
Number of unacknowledged alerts: {{previous_alerts}}
The latest sensor reading: {{latest_reading}}

If you only want an alert sent out on certain days or during certain times, you can also configure this (above the alert notification section). By clicking “Add Group of Sensors”, you can send notifications for a different group of sensors to different people. This means you don't need to create the same alert multiple times for different buildings or floors. Once you're happy with the name, conditions, sensors and notification options you've added, you can create the alert by clicking “Save” up the top right. Any changes can be made from the same Alerts overview section, by clicking “Edit” next to the alerts' name. Likewise, you can remove an alert by clicking “Delete”.

### Appendix 2: the Infogrid Legionella Compliance Solution

### The Infogrid System: Legionella Compliance Prior Art

Legionella is a category of bacteria (i.e. consisting of several different species) which are endemic in the environment and harmless in small amounts but when highly concentrated and consumed cause a pneumonia-like illness in humans called Legionnaire's disease which is often fatal and has no vaccine. It has been shown to develop in water distribution systems where water lies stagnant and within a temperature range that is conducive to the bacteria's growth (roughly 20-45° C.); in addition, any production of water droplets will increase the risk (such as a condensing cooling system).

In many countries (including the UK) there exist legal standards applied to settings where these conditions are deemed to have an appreciable risk; such as in hotels, office buildings, hospitals, and other commercial premises where irregular use of water outlets might occur. Whilst the full documentation defining UK standards is lengthy, (See: Legionnaires' disease. The control of legionella bacteria in water systems. Approved Code of Practice and guidance; Health and Safety Executive ISBN: 9780717666157), positive compliance can be broadly summarised as:
If the temperature is sustained at all times below 20° C., or equivalently at all times above 45° C.
And in any non-healthcare setting, if an outlet is used for at least 3 minutes per week
Or, in a healthcare setting, if an outlet is used for at least 3 minutes every 3 days
Or, in a high-risk healthcare setting (known as Augmented Care), if an outlet is used for at least 3 minutes each day

In order to comply with this legislation, businesses have to complete a risk assessment and, in cases where it is identified there is a risk that the above compliance may not be met (for example, an office building, hotel, or other commercial premises with an occupancy such that there is some appreciable risk that not every outlet will be used for at least 3 minutes per week) then an engineer must be dispatched to the site on a regular basis solely to turn every tap on and leave them running for the mandated 3 minutes. Besides the cost in manpower, this also flushes a substantial amount of potable water into waste.

Existing remote pipe monitoring solutions on the market are typically either a direct break in the water pipe with a physical flowmeter inserted (fairly inexpensive hardware but requires specialist plumbing knowledge to install) or an externally mounted ultrasound unit (highly costly hardware, but no specialist installation knowledge required). These solutions cannot practically be applied for the legionella case as it is far too expensive and labour-intensive to install one of each of these sensor types for every single tap outlet (rather they are designed more for whole-building monitoring or industrial use-cases).

### The Infogrid System Legionella Compliance Solution

The solution is a system for monitoring the control of legionella bacteria in a water system in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether conditions in the water pipe, based on temperature data sent from the temperature sensor, are or are not conducive to the growth of legionella bacteria.

Another aspect is not legionella specific, but more generally directed to monitor water pipe usage: A system for monitoring the use of water pipes in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether the water pipe has been used, based on temperature data sent from the temperature sensor.

We can generalise further:

A system for monitoring the value of an environmental parameter in a building, the system including:
(i) a sensor configured to measure a type of environmental parameter;
(ii) a computer implemented AI (e.g. deep learning) system running on a remote computer and that has been trained to predict or infer the value of a different parameter, based on the environmental parameter data from the sensor.

### The Hardware

An implementation of this system provides a robust, low-cost, scalable system for monitoring the use of a water pipe, and in particular whether the use of the water pipe, or the conditions in it, are sufficient to inhibit or prevent the growth of legionella bacteria.

This system is not tied to specific hardware but re-purposes the output from any suitable temperature sensor that is a connected device—i.e. can send its temperature data to an external device. The working implementation uses a low cost, data-connected temperature sensor, such as an IoT connected temperature sensor, that can measure the temperature of a water pipe and send that temperature data to a remote computer system. The system uses this low cost temperature sensor, together with a machine learning based analysis of the output from the temperature sensor. This results in a discrete and very low-cost solution that still retains very good accuracy. Because very low cost IoT temperature sensors are used, it becomes feasible to use these sensors on every water pipe in a building, e.g. in every water pipe that could potentially harbour the growth of legionella bacteria.

The working implementation uses a readily available, low cost IoT temperature sensor hardware that can be attached to a water pipe, typically with a thermal pad to give thermal connectivity between the pipe surface and the sensor, and a cable tie to attach the sensor and pad to the water pipe.

The sensor sends its readings at a radio frequency to a local relay. This relay then forwards the signal on, e.g. via cellular network, to a cloud server, from where it is ingested by the machine learning based system. Because of the compactness of this temperature sensor, it is not possible to replace its battery; however under the current production configuration the battery lasts around 5 years before the sensor would require replacement (this is assuming readings every 330 seconds).

### Gathering Control Data

In order to both develop and assess an algorithm to transform temperature inputs into a binary classification of tap was used not used then control data was required. Since no ready-made solution for a flowmeter capable of outputting its results in a digital format is available on the market, a bespoke solution was built from several components; a Hall effect flowmeter with G-½″ (standardised sized for kitchen and bathroom taps) thread provided the base measurement of water flowing. For calibration, a compatible quantitative controller was used: this displays the flow rate and total volume of water flowed based on a K-value (determined by calibration with a known volume of water); this provides the multiple from rotations of the flowmeter to flowrate of water. However, this controller only displayed values and was incapable of outputting results to a computer via an Application Programming Interface (API) so a pulse counter was connected to the flowmeter, and to that was connected a wireless connectivity module for internet connectivity through Wi-Fi.

This set-up allowed for water flow through a water pipe to be measured and output to a file at high fidelity (this was set to 1 second readings; higher would have also been possible).

Hence the flowmeter was attached to the end of the tap, and the temperature sensor was attached to the pipe feeding the tap as previously described (placement on the pipe being close by where it fed into the tap).

Upon merging the data from the temperature sensor with the flow sensor, a new feature was generated showing a binary flow no flow and it was at that point possible to select against what time frame the feature should be counted. It was selected that the binary value should indicate ‘did water flow within the last 15 minutes’. This was thought to be a reasonable match of accuracy to the use-case (to be investigated whether it might be sensible to make this even more coarse i.e. within the last hour, the last day etc given the legionella use-case only requires to know if ‘an outlet was used for at least three minutes within a week’ in general).

### Building an Algorithm

During initial product development, it was assumed that the higher the frequency of readings from the temperature sensor, the higher accuracy of the resultant model. Hence readings were taken at a frequency of 60 seconds; in order to test models at different frequencies of reading this output was then down-sampled to a lower frequency.

The length of time one wishes to look back to define the binary outcome has to be set; a variety of approaches were tested from taking 60 second readings and defining only whether the tap was in use within the previous 60 seconds as positive, to taking up the last 15 minutes and making the case that if the tap was in use during any of the previous 15 minutes that this would count as positive. In the end it was settled to use a solution taking readings every 330 seconds and considering whether the tap had been in use over the previous three readings.

Whilst a hand-crafted rules-based approach was a potential step and was considered, it was rapidly apparent that it would prove extremely challenging to hand-craft features in such a format to lead to a usable result given the complexity of the problem; in short, simple considerations such as when temperature increases in a hot pipe=>water is flowing and when temperature decreases in a hot pipe=>water is not flowing (returning to equilibrium) do not work because of the numerous temperature fluctuations that occur throughout the day both from the ambient temperature and also fluctuations from the water supply.

Furthermore, within traditional machine learning and statistical modelling formats there are few highly-performant models from this set for binary classification problems with time-series inputs and particularly given the limited nature of the input data—we consider only one feature, which is temperature. Possible additional features would relate to the time of day, and beyond this speculative features become more impractical that they could be obtained for every customer—for example whether it is in use in a certain type of environment such as a hotel or a manufacturing facility, what the settings on the water heating unit are, whether it is indoors or exposed to the outside.

Designing a working system has been aided by recent developments in neural networks allow for substantially more straightforward and simple computational performance in a reasonable amount of time (such as the libraries TensorFlow, PyTorch and Caffe) and are substantially better suited to timeseries problems.

Key components here are in the selection of the architecture of the deep learning model, its hyperparameters, and the format in which to input the data. This was based on substantial and painstaking iteration through multiple different possible formats to find the resulting high-performing model that could be deployed to customers.

The architecture follows a recurrent neural network approach; recurrent neural networks (RNN) are a class of neural networks that is powerful for modelling sequence data, such as time series.

The RNN considers each current temperature value, along with a substantial number of prior temperature values giving information on trends in temperature over the past several hours. Temperature values are taken every 330 seconds, which provides an acceptable balance between the differing interests of accuracy, battery life of the hardware, and reducing privacy concerns. A variety of layers are used in the model architecture; these create abstractions of the data that allow it to find the most important patterns. The exact hyperparameters and architecture are given below.

Since the resulting model was trained on data collected from a variety of conditions it is expected that the performance metrics can be taken as reliable across all types of customer deployments.

### Performance of the Algorithm:

| | | | False | False |
|---|---|---|---|---|
| | Accuracy | F1-Score | Positive Rate | Negative Rate |
| Infogrid Model | 92.0% | 0.902 | 0.0911 | 0.0633 |
| Baseline | 73.5% | 0.000 | 0.0000 | 1.0000 |

### Productionising the Resultant Hardware and Software Combination

TensorFlow Serving was utilised to deploy the machine learning model within the existing Amazon Web Services utilised by the company. This is pre-built system released by Tensorflow which allows for straightforward creation of API endpoint to which input data is sent are from which classification results are output.

### Recurrent Neural Network Model

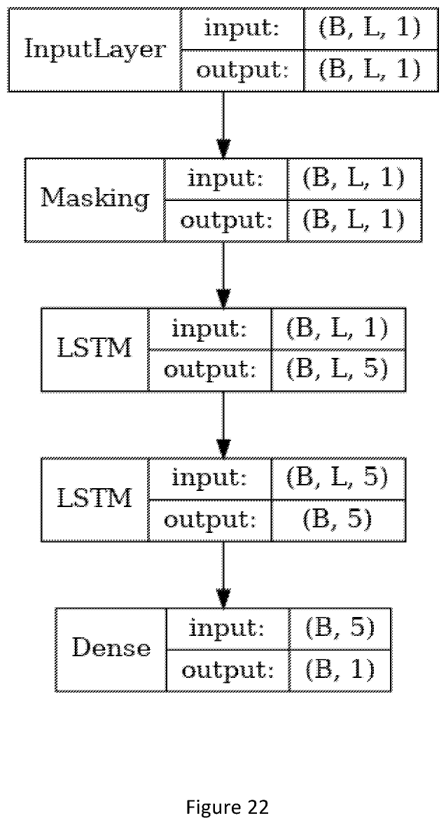

NB. The exact hyperparameters and architecture are subject to variation; better optimisations are likely to be developed over time and FIG. 22 represents the current working system.

Batch size (b) is 32 for training and 1 for inference, and the sequence length (L) is 7. We consider differences for each temperature reading, so each temperature input is compared to the previous one and the difference value is used. So we use as input at training time every temperature difference value for each reading for the sensor at 5 minute intervals in degrees centigrade and we construct a three dimensional array using each difference value, followed by the 6 temperature differences preceding it. Normalisation is not applied in this case. An Adam optimizer is used, cross entropy as the loss function, and sigmoid activation on the last dense layer, and up to 5000 epochs.

### Key Features of the Infogrid Legionella Compliance System

This Appendix lists Key Features A-E, together with a number of further, optional features. Note that any and all of the optional features can be combined with one another in any combination(s), and with any of the Key Features A-E. Note also that any of Key Features A-E can be combined with any one or more of the optional features listed for the Healthy Building Score feature described earlier.

A. A system for monitoring the control of legionella bacteria in a water system in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether conditions in the water pipe, based on temperature data sent from the temperature sensor, are or are not conducive to the growth of legionella bacteria.

### Various Optional Features:

### The Water Pipe

the water pipe is a hot water pipe
the water pipe is cold water pipe positioned, at least in part, in sufficient proximity to a hot water pipe to be heated by that hot water pipe.
the water pipe includes a water outlet, such as a tap.

### Legionella Growth Conditions

the conditions in the water pipe are whether or not water flowed in the water pipe within the last 15 minutes.
the conditions in the water pipe are whether or not the temperature has been sustained over a defined time period at below 20° C., or equivalently above 45° C.
the conditions in the water pipe are whether, in any non-healthcare setting, an outlet from the water pipe has been used for at least 3 minutes per week.
the conditions in the water pipe are whether, in a healthcare setting, an outlet from the water pipe has been used for at least 3 minutes, every 3 days.
the conditions in the water pipe are whether, in a high-risk healthcare setting, an outlet from the water pipe has been used for at least 3 minutes each day.

### The Sensor

the temperature sensor is a wireless-connected IoT temperature sensor
the temperature sensor is a wireless-connected IoT temperature sensor that is positioned in thermal contact with the water pipe.
the sensor sends temperature data to the remote computer via a secure LAN wireless link to a local relay, that in turn sends the data to the remote computer.
the temperature sensor is configured to detect the pipe temperature at pre-defined intervals, such as every five minutes.

### The AI Deep Learning System

the AI system is a deep learning system
the AI system infers water flow from changes in the measured temperature.
the deep learning system uses a neural network that is effective for modelling time series sequence data.
the deep learning system is a recurrent neural network based deep learning system.
the recurrent neural network considers each current temperature value from the temperature sensor, along with a number of prior temperature values giving information on trends in temperature.

### Training the RNN

the recurrent neural network includes a variety of layers to create abstractions of the input data that allow it to find the most important patterns in that data.
the deep learning system has been trained on control data derived from using a water flow sensor to detect the flow of water from opening an outlet to the water pipe, as well as the temperature sensor.
the deep learning system has been trained on data taken from water pipes operating across a broad range of usage patterns.
the input at training time are difference values for each temperature reading, so that each temperature input is compared to the previous one and the difference value is used for every temperature reading for the sensor at pre-set intervals, e.g. 5 minute intervals; and a three dimensional array is then constructed in which each temperature difference value is followed by a set number of the temperature difference values preceding it, e.g. the 6 temperature difference values preceding it; so that each temperature reading is considered multiple times.
a normalisation layer is then used to scale values, e.g. from 0 to 1.
an Adam optimiser, with cross entropy as the loss function is then used.
a last dense layer includes a sigmoid activation function.

### Other Aspects:

B. A method for monitoring the control of legionella bacteria in a water system in a building, the method including:
(i) operating a temperature sensor configured to detect the temperature of a water pipe and to send temperature data for receipt by a remote computer;
(ii) receiving and processing the temperature data at a computer implemented AI (e.g. deep learning) system running on the remote computer and that has been trained to predict or infer whether conditions in the water pipe, based on temperature data sent from the temperature sensor, were or were not conducive to the growth of legionella bacteria;
(iii) outputting from the computer implemented AI (e.g. deep learning) system an indication of whether conditions in the water pipe were or were not conducive to the growth of legionella bacteria.
C. A system for monitoring the use of water pipes in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether the water pipe has been used, based on temperature data sent from the temperature sensor.

D. A method for monitoring the use of water pipes in a building, the method including:
(i) operating a temperature sensor configured to detect the temperature of a water pipe and to send temperature data for receipt by a remote computer;
(ii) receiving and processing the temperature data at a computer implemented AI (e.g. deep learning) system running on the remote computer and that has been trained to predict or infer whether the water pipe has been used, based on temperature data sent from the temperature sensor;
(iii) outputting from the computer implemented AI (e.g. deep learning) system an indication of whether and/or when the water pipe has been used.

We can also generalise beyond an AI based system to any computer configured to predict or infer whether conditions in the water pipe, based on temperature data sent from wireless IoT temperature sensors, and/or water flow sensors, are or are not conducive to the growth of legionella bacteria.
E. A system for monitoring the control of legionella bacteria in a water system in a building, the system including:
(i) a network of one or more wireless IoT sensors configured to detect the temperature and/or water flow for a water pipe and to send data for receipt by a remote computer;
(ii) a computer implemented system running on the remote computer and that is configured to predict or infer whether conditions in the water pipe, based on data sent from the sensor, are or are not conducive to the growth of legionella bacteria.

### Optional Features:

### The Water Pipe

the water pipe is a hot water pipe
the water pipe is cold water pipe positioned, at least in part, in sufficient proximity to a hot water pipe to be heated by that hot water pipe.
the water pipe includes a water outlet, such as a tap.

### Legionella Growth Conditions

the conditions in the water pipe are whether or not water flowed in the water pipe within the last 15 minutes.
the conditions in the water pipe are whether or not the temperature has been sustained over a defined time period at below 20° C., or equivalently above 45° C.
the conditions in the water pipe are whether, in any non-healthcare setting, an outlet from the water pipe has been used for at least 3 minutes per week.
the conditions in the water pipe are whether, in a healthcare setting, an outlet from the water pipe has been used for at least 3 minutes, every 3 days.
the conditions in the water pipe are whether, in a high-risk healthcare setting, an outlet from the water pipe has been used for at least 3 minutes each day.

### The Sensor

a sensor is a wireless-connected IoT temperature sensor
a sensor is a wireless-connected IoT temperature sensor that is positioned in thermal contact with the water pipe.
a sensor is configured to detect the pipe temperature at pre-defined intervals, such as every five minutes.
a sensor is a wireless-connected IoT water flow sensor
a sensor is configured to detect the water flow at pre-defined intervals, such as every five minutes.
a sensor sends data to the remote computer via a secure LAN wireless link to a local relay, that in turn sends the data to the remote computer.

### The User Interface

the computer implemented system displays on a user interface whether conditions in the water pip, are or are not conducive to the growth of legionella bacteria.
the user interface also display a schematic or other representation of the building layout or floor plan.
the schematic or other representation of the building layout or floor plan in the user interface shows the type of sensors in a given area and the scores for each type of sensor.
the user interface displays when the data from a sensor was last updated
the user interface displays the wireless signal strength associated with a sensor.
the user interface gives a schematic presentation of one or more floor plans for the building, the floor plan including icons representing one or more of: desks, chairs, tables, sofas, kitchens, bathrooms, and user can select an area in the floor plan and a summary of the sensor data for that selected area
an end-user defines the content of the user interface by selecting from a number of different widgets (namely an application, or a component of an interface, that enables a user to perform a function or access a service), the widgets including one of more of the following; Desk occupancy; Touch count; Proximity count; Proximity and Touch Count; Cubicle occupancy stoplight; People counting stoplight; floor plan; indoor air quality; desk occupancy heatmap; pipe monitoring (e.g. L8 Legionella risk or compliance); daily predicted issues; healthy building score; smart cleaning; CO2 concentration; office usage; bathroom visits counter; cold storage compliance.
the user interface displays indoor air quality on a per room basis, with an overall average, and also individual parameters including one or more of: CO2, virus risk, temp, humidity, temperature, air pressure, particulate matter, TVOC, noise.
the user interface displays a cleaning widget where a user can define how many times a space, such as a toilet, is used before it is cleaned and sensors automatically count usage and the system then automatically determines if the space needs cleaning, and the cleaning status of the space is shown on the user interface, e.g. on a floor plan that shows the location of the space.
the user interface displays a desk occupancy heatmap that graphically represents the level of desk occupancy as a function of day of the week and time.
the user interface displays an automatically generated description of one or more predicted issues or problems associated with environmental performance scores that exceed thresholds.
the user interface is implemented by a web app.
the system is configured to generate alert if one or parameters satisfy a predefined condition.

### Infogrid Legionella Compliance Solution Feature List

1. A system for monitoring the control of legionella bacteria in a water system in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether conditions in the water pipe, based on temperature data sent from the temperature sensor, are or are not conducive to the growth of legionella bacteria.

### The Water Pipe

2. The system of Feature 1 in which the water pipe is a hot water pipe.

3. The system of Feature 1 or 2 in which the water pipe is a cold water pipe positioned, at least in part, in sufficient proximity to a hot water pipe to be heated by that hot water pipe.

4. The system of any preceding Feature in which the water pipe includes a water outlet, such as a tap.

### Legionella Growth Conditions

5. The system of Feature 1 in which the conditions in the water pipe are whether or not water flowed in the water pipe within the last 15 minutes.

6. The system of Feature 1 in which the conditions in the water pipe are whether or not the temperature has been sustained over a defined time period at below 20° C., or equivalently above 45° C.

7. The system of Feature 1 in which the conditions in the water pipe are whether, in any non-healthcare setting, an outlet from the water pipe has been used for at least 3 minutes per week.

8. The system of Feature 1 in which the conditions in the water pipe are whether, in a healthcare setting, an outlet from the water pipe has been used for at least 3 minutes, every 3 days.

9. The system of Feature 1 in which the conditions in the water pipe are whether, in a high-risk healthcare setting, an outlet from the water pipe has been used for at least 3 minutes each day.

### The Sensor

10. The system of any preceding Feature in which the temperature sensor is a wireless-connected IoT temperature sensor.

11. The system of any preceding Feature in which the temperature sensor is a wireless-connected IoT temperature sensor that is positioned in thermal contact with the water pipe.

12. The system of any preceding Feature in which the sensor sends temperature data to the remote computer via a secure LAN wireless link to a local relay, that in turn sends the data to the remote computer.

13. The system of any preceding Feature in which the temperature sensor is configured to detect the pipe temperature at pre-defined intervals, such as every five minutes.

### The Deep Learning System

14. The system of any preceding Feature in which the AI system is a dep learning system that uses a neural network that is effective for modelling time series sequence data.

15. The system of any preceding Feature in which the deep learning system is a recurrent neural network based deep learning system.

16. The system of any preceding Feature in which the recurrent neural network considers each current temperature value from the temperature sensor, along with a number of prior temperature values giving information on trends in temperature.

### Training the RNN

17. The system of any preceding Feature in which the recurrent neural network includes a variety of layers to create abstractions of the input data that allow it to find the most important patterns in that data.

18. The system of any preceding Feature in which the deep learning system has been trained on control data derived from using a water flow sensor to detect the flow of water from opening an outlet to the water pipe, as well as the temperature sensor.

19. The system of any preceding Feature in which the deep learning system has been trained on data taken from water pipes operating across a broad range of usage patterns.

20. The system of any preceding Feature in which the input at training time are difference values for each temperature reading, so that each temperature input is compared to the previous one and the difference value is used for every temperature reading for the sensor at pre-set intervals, e.g. 5 minute intervals; and a three dimensional array is then constructed in which each temperature difference value is followed by a set number of the temperature difference values preceding it, e.g. the 6 temperature difference values preceding it; so that each temperature reading is considered multiple times.

21. The system of any preceding Feature in which a normalisation layer is then used to scale values, e.g. from 0 to 1.

22. The system of any preceding Feature in which an Adam optimiser, with cross entropy as the loss function is then used.

23. The system of any preceding Feature in which a last dense layer includes a sigmoid activation function.

24 A method for monitoring the control of legionella bacteria in a water system in a building, the method including:
(i) operating a temperature sensor configured to detect the temperature of a water pipe and to send temperature data for receipt by a remote computer;
(ii) receiving and processing the temperature data at a computer implemented AI (e.g. deep learning) system running on the remote computer and that has been trained to predict or infer whether conditions in the water pipe, based on temperature data sent from the temperature sensor, were or were not conducive to the growth of legionella bacteria;
(iii) outputting from the computer implemented AI (e.g. deep learning) system an indication of whether conditions in the water pipe were or were not conducive to the growth of legionella bacteria.

25. The method defined in preceding Feature 24, in which the temperature sensor and the AI or deep learning system are described in any preceding System claim.

26. A system for monitoring the use of water pipes in a building, the system including:
(i) a temperature sensor configured to detect the temperature of a water pipe and to send temperature data for receipt by a remote computer;
(ii) a computer implemented AI (e.g. deep learning) system running on the remote computer and that has been trained to predict or infer whether the water pipe has been used, based on temperature data sent from the temperature sensor.

27. A method for monitoring the use of water pipes in a building, the method including:
(i) operating a temperature sensor configured to detect the temperature of a water pipe and to send temperature data for receipt by a remote computer;
(ii) receiving and processing the temperature data at a computer implemented AI (e.g. deep learning) system running on the remote computer and that has been trained to predict or infer whether the water pipe has been used, based on temperature data sent from the temperature sensor;
(iii) outputting from the computer implemented AI (e.g. deep learning) system an indication of whether and/or when the water pipe has been used.

### APPENDIX 3: THE INFOGRID DESK OCCUPANCY SOLUTION

This Appendix 3 describes the Infogrid system for analysing the use of office space, such as measuring desk occupancy, e.g. in an office, call centre or other building.

### The Infogrid System: Desk Occupancy Prior Art

There are essentially three use-cases for monitoring whether a desk is in use within an office space:
Monitor specific staff members and their presence at their desk as a proxy for their productivity
Monitor the extent to which office space is utilised in a general sense and whether or not a redesign of the layout might be more optimal or whether more or fewer desks might be required
Part of a hot-desk booking system that could allow a booking to be automatically released if the expected occupant does not arrive within a set time period

Typical solutions on the market use bulky and expensive light-based sensors that can offer essentially 100% accuracy but may be considered intrusive by staff and raise privacy concerns. Sophisticated computer vision systems can also be used to identify individual people in a space and their location and movements in that space. Again, these systems are costly, may be considered intrusive by staff and raise privacy concerns.

### The Infogrid System Desk Occupancy Solution

The desk occupancy solution is a system for detecting the presence of a person at a specific location, the system including:
(i) a temperature sensor configured to detect the air temperature at the location and to send temperature data for receipt by a remote computer;
(ii) a computer implemented AI (e.g. deep learning) system running on the remote computer and that has been trained to predict or infer whether a person was or was not at the location based on air temperature data sent from the temperature sensor.

An implementation of the system addresses primarily the need to monitor the extent to which office space is utilised in a general sense and whether or not a redesign of the layout might be more optimal, or whether more or fewer desks might be required. The term ‘office’ should be expansively construed to include any environment and where localised heating of the air associated with the presence of a person can be detected by a temperature sensor.

This system can be used wherever the presence of people needs to be assessed, using a low-cost, robust system that preserves personal privacy. It can be used to monitor specific staff members and their presence at their desk as a proxy for their productivity; it can be used as part of a hot-desk booking system that could allow a booking to be automatically released if the expected occupant does not arrive within a set time period. It can be used to determine if specific desks have been occupied sufficiently to justify cleaning those desks and/or the area around them. It can be used to enable the analysis of the use of restaurant space, including occupancy and turn-around time of tables at fastfood restaurants. It can be used to determine if specific desks have been occupied in conformity with any social distancing rules designed to reduce the risk of pathogen transmission. It can be used for ‘smart cleaning’—e.g. cleaners can be tasked with only cleaning desks or other locations that have actually been used.

The system uses a low cost temperature sensor, with machine learning based analysis of the output from the temperature sensor. This results in a discrete and very low-cost solution that still retains very good accuracy. The current production algorithm takes a reading only once every 5 minutes, and so also reduces privacy concerns compared with other solutions as it does not track the minutiae of employee presence moment-to-moment but rather coarser trends. The system is also capable of reading temperature more frequently; this is limited by the maximum frequency of readings the temperature sensor is capable of. The ML-based algorithm could straightforwardly be adjusted to more or less frequent readings.

The key to making this work with high accuracy is to couple the temperature sensor hardware with a machine learning based algorithm.

### The Hardware

The system is not tied to specific hardware, but re-purposes the output from any suitable temperature sensor that is a connected device—i.e. can send its temperature data to an external device. The working implementation uses a readily available, low cost temperature sensor hardware that can be stuck underneath a desk. The sensor measures 19×19×2.5 mm and can hence fit discretely under a desk by attachment with adhesive. When a user's legs are present under the desk, they emit heat, and raise the temperature in the vicinity above the surrounding room temperature; that temperature is measured by the sensor. The desk acts to trap the warmed air and to minimise draughts and air currents that would otherwise dissipate the locally warmed air. When the desk becomes unoccupied, the temperature measured by the sensor rapidly returns to ambient temperature. A temperature sensor can be placed underneath every desk that needs monitoring.

Implementations of the system can be used in an office building where staff sit at desks to work; it can be used in a restaurant where diners sit at tables or at any other location where the localised warming of air associated with the presence of a person can be detected.

The temperature sensor sends its readings at a radio frequency over a secure connection to a local relay. This relay then forwards the temperature readings via a cellular connection to a cloud-based server, from where it is ingested by a machine learning based system. Because of the compactness of this temperature sensor, it is not possible to replace its battery; however under the current production configuration the battery lasts around 3 years before the sensor would require replacement.

### Gathering Control Data

In order to both develop and assess an algorithm to transform temperature inputs into a binary classification of desk occupied not occupied then control data was required. For this, a wireless proximity sensor was placed on to a chair corresponding to the desk to which a temperature sensor was installed. When the user is sat (or not sat) at their chair, the proximity sensor will indicate this and act as the control data to be fed into the algorithm along with the feature data from the temperature sensor. This allows not only training but, more critically, assessment. In order to accommodate risks of over-fitting to a single office environment, control sensor pairs were deployed across several sites. This included 6 in the Infogrid London office (air conditioned), 4 in the Infogrid Tallinn office (air conditioned), and 3 located in separate homes of Infogrid staff (non air conditioned). In total readings were taken over a period of 6 months (July 2020 to January 2021), though not all of the deployed sensors were online for this whole period.

It would be possible to locate the temperature sensor at another location, such as on the legs of the desk. This was however never tested as it was deemed likely to be intrusive for the user if the sensor was more highly visible; intuition suggests that one would always expect a less marked temperature differential than in the indicated position.

Finally it is worth noting that the placement of a proximity sensor on the chair as an alternative solution to present to customers was considered unacceptable because of:
The difficulty in keeping the proximity sensor attached to the chair without damaging the chair
The diminished lifetime of the proximity sensors that was observed in these experiments; it is speculated that by being placed on a non-flat surface they became subject to shear stresses
The intrusive nature of having a highly visible sensor attached to the chair
The likelihood that a chair be moved around in a typical office environment and thus become separated from any one particular desk

### Building an Algorithm

During initial development, it was assumed that the higher the frequency of readings from the temperature sensor, the higher accuracy of the resultant model. Hence readings were taken at a frequency of 60 seconds; in order to test models at different frequencies of reading this output was then downsampled to a lower frequency.

First, it is worth noting that the majority of the time a chair is unoccupied; indeed, with the control data gathered it was found that by predicting unoccupied at all times (i.e. no algorithm at all) one would return around 90% accuracy. Hence, algorithms were optimised for and assessed against an F1-score. This metric returns 0 for such a case when only one of the two available outcomes is predicted, making it a more useful metric in an unbalanced dataset.

Whilst a hand-crafted rules-based approach was a potential step and was considered, it was rapidly apparent that it would prove extremely challenging to hand-craft features in such a format to lead to a usable result given the complexity of the problem; in short, simple considerations such as when temperature increases=>occupied and when temperature decreases=>unoccupied do not work because of the numerous temperature fluctuations that occur throughout the day (even in an air conditioned environment) from such variations as sun coming through a window, a door or window being opened, or simply the movement of a person close by leading to fluctuations of air movement in the proximity of the temperature sensor.

Furthermore, within traditional machine learning and statistical modelling formats there are few highly-performant models from this set for binary classification problems with time-series inputs and particularly given the limited nature of the input data—we consider only one feature, which is temperature. Possible additional features would relate to the time of day, and beyond this speculative features become more impractical that they could be obtained for every customer—for example whether a window is nearby, in what orientation the desk is in relation to the sun and other heat sources, etc.

Designing a working system has been aided by recent developments in neural networks allow for substantially more straightforward and simple computational performance in a reasonable amount of time (such as the libraries TensorFlow, PyTorch and Caffe) and are substantially better suited to timeseries problems.

Key components are in the selection of the architecture of the deep learning model, its hyperparameters, and the format in which to input the data. This was based on substantial and painstaking iteration through multiple different possible formats to find the high-performing model that could be deployed to customers.

The architecture follows a recurrent neural network approach; recurrent neural networks (RNN) are a class of neural networks that is powerful for modelling sequence data, such as time series.

The RNN considers each current temperature value, along with a substantial number of prior temperature values giving information on trends in temperature over the past several hours. Temperature values are taken every 330 seconds, which provides an acceptable balance between the differing interests of accuracy, battery life of the hardware, and reducing privacy concerns. A variety of layers are used in the model architecture; these create abstractions of the data that allow it to find the most important patterns. The exact hyperparameters and architecture are given in Appendix 1.

Since the resulting model was trained on data collected from a variety of conditions—air conditioned and not, including direct sunlight from windows and not, day and night conditions, and across seasons, across different individual seating styles, including standing desks as well as sitting, it is expected that the performance metrics can be taken as reliable across all types of customer deployments.

The resulting model output the following metrics, and these are placed in comparison with both our baseline (considering all values to be unoccupied) and a conventional, open-source rules-based algorithm:

| | | | False | False |
|---|---|---|---|---|
| | Accuracy | F1-Score | Positive Rate | Negative Rate |
| Infogrid Model | 97.3% | 0.829 | 0.010 | 0.213 |
| Baseline | 91.6% | 0.000 | 0.000 | 1.000 |
| Rules-based | 89.1% | 0.400 | 0.067 | 0.568 |
| algorithm | | | | |

And note that further development continues to improve the Infogrid model; rather these results are quoted to demonstrate the performance for an early implementation of the innovation. Current implementations utilise information on which desks are located together in space to feed those datapoints on temperature of those sensors also into the model, whereas previously each desk was an independent model. This improves accuracy.

The system now utilise the time and day of the reading (based on knowing the building's location, from which the system can infer what time zone it is in) to influence the model—i.e. if a reading is positive on a Sunday afternoon this is more likely to be suppressed and marked as negative as training data shows the majority of usage on weekdays.

### Productionising the Resultant Hardware and Software Combination

TensorFlow Serving was utilised to deploy the machine learning model within the existing Amazon Web Services utilised by the company. This is pre-built system released by TensorFlow which allows for straightforward creation of an API endpoint to which input data is sent and from which classification results are output.

### Recurrent Neural Network Model

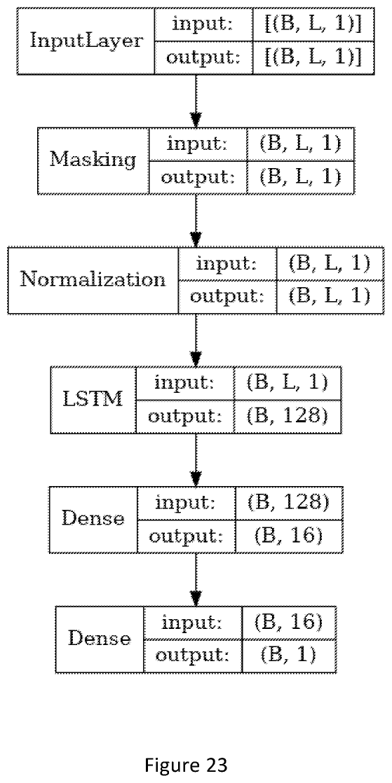

NB. The exact hyperparameters and architecture are subject to variation; better optimisations are likely to be developed over time and FIG. 23 represents our current working system.

B is the batch size which is 32 in training and 1 in inference. L is the sequence length which is 20. So we take as input at training time every temperature reading for the sensor at 5 minute intervals in degrees centigrade and we construct a three dimensional array where each reading is followed by the 19 temperature readings preceding it. The next value then also has the previous 19 and so in this way Each temperature reading is considered multiple times. We then include a normalisation layer which you can see in the architecture, such that values are scaled 0-1. We use an Adam optimiser with Keras defaults, cross entropy as the loss function, and the last dense layer includes a sigmoid activation function. We trained on up to 5000 epochs.

### Key Features of the Infogrid Desk Occupancy Solution

This Appendix lists key features A-B, together with a number of further, optional features. Note that any and all of the optional features can be combined with one another in any combination(s), and with any of the key features A-B.

A. A system for detecting the presence of a person at a specific location, the system including
(i) a temperature sensor configured to detect the air temperature at the location and to send temperature data for receipt by a remote computer;
(ii) a computer implemented AI (e.g. deep learning) system running on the remote computer and that has been trained to predict or infer whether a person was or was not at the location based on air temperature data sent from the temperature sensor.

### Various Optional Features:

### The Location

the location is any environment where localised heating of the air associated with the presence of a person can be detected by a temperature sensor.
the location is a desk in an office.
the location is a desk and the temperature sensor is positioned underneath the desk, such as above the typical location of a user's legs.

### The Sensor

the sensor is a wireless-connected IoT temperature sensor
the location is a desk and the temperature sensor is a wireless-connected IoT temperature sensor that is positioned underneath the desk.
the sensor sends temperature data to the remote computer via a secure LAN wireless link to a local relay, that in turn sends the data to the remote computer.
the temperature sensor is configured to detect the air temperature at pre-defined intervals, such as every five minutes.

### The Deep Learning System

the AI system is a deep learning system
the deep learning system uses a neural network that is effective for modelling time series sequence data.
the deep learning system is a recurrent neural network based deep learning system.
the recurrent neural network considers each current temperature value from the temperature sensor, along with a number of prior temperature values giving information on trends in temperature over the past several hours.

### Training the RNN

the recurrent neural network includes a variety of layers to create abstractions of the input data that allow it to find the most important patterns in that data.
the deep learning system has been trained on control data derived from using a proximity sensor to detect the presence of a person, as well as the temperature sensor.
the deep learning system has been trained on data taken from office environments that cover one or more or all of the following variables: air conditioned and not; including direct sunlight from windows and not; day and night conditions; across seasons; across different individual seating styles; including standing desks as well as sitting.
the input at training time is every temperature reading for the sensor at pre-set intervals, e.g. 5 minute intervals, and a three dimensional array is then constructed in which each reading is followed by a set number of the temperature readings preceding it, e.g. the 19 temperature readings preceding it; and the next value then also has the same previous number of readings, so that each temperature reading is considered multiple times.
a normalisation layer is then used to scale values, e.g. from 0 to 1.
an Adam optimiser, with cross entropy as the loss function is then used.
a last dense layer includes a sigmoid activation function.

### Use Cases

The system enables the analysis of the use of office space.
The system is configured to monitor the extent to which office space is utilised.
The system is configured to enable an assessment of whether or not to redesign an office layout.
The system is configured to enable an assessment of whether or not more or fewer desks are required.
The system is configured to monitor staff presence and the time staff spend at their desks.
The system is configured to monitor staff presence at their desks as a proxy for their productivity.
The system is configured to be used as part of a hot-desk booking system.
The system is configured to be used to allow a hot desk booking to be automatically released if the expected occupant does not arrive within a set time period.
The system enables the analysis of the use of restaurant space, including occupancy of fast food tables.
The system is configured to determine if specific desks have been occupied sufficiently to justify cleaning those desks and/or the area around them.
The system is configured to determine if specific desks have been occupied in conformity with any social distancing rules designed to reduce the risk of pathogen transmission.

### The User Interface

the computer implemented system displays on a user interface whether a person was or was not at the location.
the user interface also display a schematic or other representation of the building layout or floor plan.
the schematic or other representation of the building layout or floor plan in the user interface shows the type of sensors in a given area and the scores for each type of sensor.
the user interface displays when the data from a sensor was last updated
the user interface displays the wireless signal strength associated with a sensor.
the user interface gives a schematic presentation of one or more floor plans for the building, the floor plan including icons representing one or more of: desks, chairs, tables, sofas, kitchens, bathrooms, and user can select an area in the floor plan and a summary of the sensor data for that selected area
an end-user defines the content of the user interface by selecting from a number of different widgets (namely an application, or a component of an interface, that enables a user to perform a function or access a service), the widgets including one of more of the following: Desk occupancy; Touch count; Proximity count; Proximity and Touch Count; Cubicle occupancy stoplight; People counting stoplight; floor plan; indoor air quality; desk occupancy heatmap; pipe monitoring (e.g. L8 Legionella risk or compliance); daily predicted issues; healthy building score; smart cleaning; CO2 concentration; office usage; bathroom visits counter; cold storage compliance.
the user interface displays indoor air quality on a per room basis, with an overall average, and also individual parameters including one or more of: CO2, virus risk, temp, humidity, temperature, air pressure, particulate matter, TVOC, noise.
the user interface displays a cleaning widget where a user can define how many times a space, such as a toilet, is used before it is cleaned and sensors automatically count usage and the system then automatically determines if the space needs cleaning, and the cleaning status of the space is shown on the user interface, e.g. on a floor plan that shows the location of the space.
the user interface displays a desk occupancy heatmap that graphically represents the level of desk occupancy as a function of day of the week and time.
the user interface displays an automatically generated description of one or more predicted issues or problems associated with environmental performance scores that exceed thresholds.
the user interface is implemented by a web app.
the system is configured to generate alert if one or parameters satisfy a predefined condition.

B. A method of analysing the use of office space, comprising the steps of:
(i) operating a temperature sensor configured to detect the air temperature at a location and to send temperature data for receipt by a remote computer;
(ii) receiving and processing the temperature data at a computer implemented AI (e.g. deep learning) system running on the remote computer and that has been trained to predict or infer whether a person was or was not at the location based on the air temperature measured by the temperature sensor;
(iii) using the output of the computer implemented AI (e.g. deep learning) system to analyse use of office space.

### Use Cases

the output of the computer implemented AI (e.g. deep learning) system is used to monitor the extent to which office space is utilised.
the output of the computer implemented AI (e.g. deep learning) system is used to assess whether or not to redesign an office layout.
the output of the computer implemented AI (e.g. deep learning) system is used to assess whether or not more or fewer desks are required.
the output of the computer implemented AI (e.g. deep learning) system is used to monitor staff presence and the time staff spend at their desks.
the output of the computer implemented AI (e.g. deep learning) system is used to monitor staff presence at their desks as a proxy for their productivity.
the output of the computer implemented AI (e.g. deep learning) system is used as part of a hot-desk booking system.
the output of the computer implemented AI (e.g. deep learning) system is used to allow a hot desk booking to be automatically released if the expected occupant does not arrive within a set time period.
the output of the computer implemented AI (e.g. deep learning) system is used to determine if specific desks have been occupied sufficiently to justify cleaning those desks and/or the area around them.
the output of the computer implemented AI (e.g. deep learning) system is used to determine if specific desks have been occupied in conformity with any social distancing rules designed to reduce the risk of pathogen transmission.
the temperature sensor and the AI (e.g. deep learning) system are as described above.

### Infogrid Desk Occupancy Solution Feature List

1. A system for detecting the presence of a person at a specific location, the system including
(i) a temperature sensor configured to detect the air temperature at the location and to send temperature data for receipt by a remote computer;
(ii) a computer implemented AI (e.g. deep learning) system running on the remote computer and that has been trained to predict or infer whether a person was or was not at the location based on air temperature data sent from the temperature sensor.

### The Location

2. The system of Feature 1 in which the location is any environment where localised heating of the air associated with the presence of a person can be detected by a temperature sensor.

3. The system of Feature 1 or 2 in which the location is a desk in an office.

4. The system of any preceding Feature in which the location is a desk and the temperature sensor is positioned underneath the desk, such as above the typical location of a user's legs.

### The Sensor

5. The system of any preceding Feature in which the sensor is a wireless-connected IoT temperature sensor.

6. The system of any preceding Feature in which the location is a desk and the temperature sensor is a wireless-connected IoT temperature sensor that is positioned underneath the desk.

7. The system of any preceding Feature in which the sensor sends temperature data to the remote computer via a secure LAN wireless link to a local relay, that in turn sends the data to the remote computer.

8. The system of any preceding Feature in which the temperature sensor is configured to detect the air temperature at pre-defined intervals, such as every five minutes.

### The Deep Learning System

9. The system of any preceding Feature in which the deep learning system uses a neural network that is effective for modelling time series sequence data.

10. The system of any preceding Feature in which the deep learning system is a recurrent neural network based deep learning system.

11. The system of any preceding Feature in which the recurrent neural network considers each current temperature value from the temperature sensor, along with a number of prior temperature values giving information on trends in temperature over the past several hours.

### Training the RNN

12. The system of any preceding Feature in which the recurrent neural network includes a variety of layers to create abstractions of the input data that allow it to find the most important patterns in that data.

13. The system of any preceding Feature in which the deep learning system has been trained on control data derived from using a proximity sensor to detect the presence of a person, as well as the temperature sensor.

14. The system of any preceding Feature in which the deep learning system has been trained on data taken from office environments that cover one or more or all of the following variables: air conditioned and not; including direct sunlight from windows and not; day and night conditions; across seasons; across different individual seating styles; including standing desks as well as sitting.

15. The system of any preceding Feature in which the input at training time is every temperature reading for the sensor at pre-set intervals, e.g. 5 minute intervals, and a three dimensional array is then constructed in which each reading is followed by a set number of the temperature readings preceding it, e.g. the 19 temperature readings preceding it; and the next value then also has the same previous number of readings, so that each temperature reading is considered multiple times.

16. The system of any preceding Feature in which a normalisation layer is then used to scale values, e.g. from 0 to 1.

17. The system of any preceding Feature in which an Adam optimiser, with cross entropy as the loss function is then used.

18. The system of any preceding Feature in which a last dense layer includes a sigmoid activation function.

### Use Cases

19. The system of any preceding Feature which enables the analysis of the use of office space.

20. The system of any preceding Feature which is configured to monitor the extent to which office space is utilised.

21. The system of any preceding Feature which is configured to enable an assessment of whether or not to redesign an office layout.

22. The system of any preceding Feature which is configured to enable an assessment of whether or not more or fewer desks are required.

23. The system of any preceding Feature which is configured to monitor staff presence and the time staff spend at their desks.

24. The system of any preceding Feature which is configured to monitor staff presence at their desks as a proxy for their productivity.

25. The system of any preceding Feature which is configured to be used as part of a hot-desk booking system.

26. The system of any preceding Feature which is configured to be used to allow a hot desk booking to be automatically released if the expected occupant does not arrive within a set time period.

27. The system of any preceding Feature which enables the analysis of the use of restaurant space, including occupancy of fast food tables.

28. The system of any preceding Feature which is configured to determine if specific desks have been occupied sufficiently to justify cleaning those desks and/or the area around them.

29. The system of any preceding Feature which is configured to determine if specific desks have been occupied in conformity with any social distancing rules designed to reduce the risk of pathogen transmission.

30. A method of analysing the use of office space, comprising the steps of:
(i) operating a temperature sensor configured to detect the air temperature at a location and to send temperature data for receipt by a remote computer;
(ii) receiving and processing the temperature data at a computer implemented AI (e.g. deep learning) system running on the remote computer and that has been trained to predict or infer whether a person was or was not at the location based on the air temperature measured by the temperature sensor;
(iii) using the output of the computer implemented AI (e.g. deep learning) system to analyse use of office space.

### Use Cases

31. The method of analysing the use of office space defined in Feature 30, in which the output of the computer implemented AI (e.g. deep learning) system is used to monitor the extent to which office space is utilised.

32. The method of analysing the use of office space defined in Feature 30-31, in which the output of the computer implemented AI (e.g. deep learning) system is used to assess whether or not to redesign an office layout.

33. The method of analysing the use of office space defined in Feature 30-32, in which the output of the computer implemented AI (e.g. deep learning) system is used to assess whether or not more or fewer desks are required.

34 The method of analysing the use of office space defined in Feature 30-33, in which the output of the computer implemented AI (e.g. deep learning) system is used to monitor staff presence and the time staff spend at their desks.

35. The method of analysing the use of office space defined in Feature 30-34, in which the output of the computer implemented AI (e.g. deep learning) system is used to monitor staff presence at their desks as a proxy for their productivity.

36. The method of analysing the use of office space defined in Feature 30-35, in which the output of the computer implemented AI (e.g. deep learning) system is used as part of a hot-desk booking system.

37. The method of analysing the use of office space defined in Feature 30-36, in which the output of the computer implemented AI (e.g. deep learning) system is used to allow a hot desk booking to be automatically released if the expected occupant does not arrive within a set time period.

38. The method of analysing the use of office space defined in Feature 30-37, in which the output of the computer implemented AI (e.g. deep learning) system is used to determine if specific desks have been occupied sufficiently to justify cleaning those desks and/or the area around them.

39. The method of analysing the use of office space defined in Feature 30-38, in which the output of the computer implemented AI (e.g. deep learning) system is used to determine if specific desks have been occupied in conformity with any social distancing rules designed to reduce the risk of pathogen transmission.

40. The method of analysing the use of office space defined in any preceding Feature 30-39, in which the temperature sensor and the AI (e.g. deep learning) system are described in any preceding System claim.

1. A method of monitoring a building, comprising the steps of:
(a) using a network of sensors in the building to measure multiple different environmental performance parameters, in which a sensor in the network measures a specific environmental performance parameter;
(b) using a computer implemented AI (e.g. deep learning) system running on a computer and that has been trained to predict or infer a different environmental performance parameter, based on the specific environmental performance parameter;
(c) automatically processing that different environmental performance parameter, as well as environmental performance parameters from other sensors, using a scoring algorithm running on a processor, to generate an overall healthy building score.

2. (canceled)

3. The method of claim 1 in which the environmental performance parameters include values for, or related to, one or more of the following: CO2; radon; volatile organic compounds; particulate matter (including dust); humidity; air pressure; light levels; air temperature; localised temperature below a desk; noise levels; presence of water; water leaks; water quality; water pipe temperature; legionella compliance; cold storage compliance; proximity of objects (such as for measuring whether doors, vents, windows are open or closed); desk occupancy; room occupancy; button presses (such as for registering occupant satisfaction on a feedback panel); compliance with a cleaning regime.

4. The method of claim 1 in which one or more of the sensors each automatically generate or are otherwise associated with an environmental performance score that depends on the value of the environmental performance parameters measured by the sensor.

5. The method of claim 1 which includes automatically processing the environmental performance parameters, using an AI, e.g. deep learning system, trained to generate the healthy building score using a scoring algorithm running on a processor.

6. (canceled)

7. The method of claim 4 in which the environmental performance score of a sensor is derived from the proportion of time a sensor's reading is spent outside of a defined optimal (or healthy) range for that sensor's reading type and the environmental performance score of a sensor is weighted depending on how recently the sensor has generated that score.

8. (canceled)

9. (canceled)

10. The method of claim 4 in which the scoring algorithm (i) aggregates the environmental performance scores from multiple sensors, measuring multiple different environmental performance parameters and uses a hierarchical algorithm in which the hierarchy is based both on the type of the sensor measurement and its relative spatial location within a building and (ii) organises sensors into a hierarchy of physical locations, such as floor of a building, then a room in a building, then an area in a room, then specific sensor(s) in that area.

11. (canceled)

12. (canceled)

13. (canceled)

14. (canceled)

15. The method of claim 4 in which the environmental performance scores of sensors are aggregated to give a queryable score for one or more hierarchies of physical locations, e.g. an aggregated score for the sensors of a specific type in an area; an aggregated score for sensors of that specific type in a room containing that specific area; an aggregated score for sensors of that specific type in a floor including that room; an aggregated score for sensors of that specific type across all floors.

16. The method of any preceding-claim 4 in which the environmental performance scores of sensors are aggregated to give a healthy building score, being an overall healthy building score that is a single score or value, and that single store or value is an aggregated score for sensors across all types and across all floors.

17. (canceled)

18. (canceled)

19. (canceled)

20. (canceled)

21. The method of claim 1 in which the network of sensors includes sensors inside the building, and one or more of the following locations: on external walls or roofs of the building; wholly external to the building; in the local neighbourhood in which the building is situated, distant from the local neighbourhood in which the building is situated.

22. (canceled)

23. The method of claim 1 in which a water pipe temperature sensor, attached to a water pipe, generates data analysed by the computer implemented AI system running a deep learning algorithm trained to predict or infer whether conditions in the water pipe, based on temperature data sent from the temperature sensor, are or are not conducive to the growth of legionella bacteria.

24. (canceled)

25. The method of claim 1 in which a temperature sensor is configured to detect the air temperature at a location, such as a desk, and to send temperature data for receipt by a remote computer; and the computer implemented AI system running on a computer, has been trained to predict or infer whether a person was or was not at the location based on air temperature data sent from the temperature sensor, analyses the temperature data.

26. (canceled)

27. The method of claim 1 in which the overall healthy building score is displayed on a computer user interface, and the user interface also display a schematic or other representation of the building layout or floor plan.

28. (canceled)

29. (canceled)

30. (canceled)

31. The method of claim 27 in which the user interface gives a schematic presentation of one or more floor plans for the building, the floor plan including icons representing one or more of: desks, chairs, tables, sofas, kitchens, bathrooms, and user can select an area in the floor plan and a summary of the sensor data for that selected area.

32. The method of claim 27 in which the user interface includes a numeric, percentage representing the overall healthy building score.

33. The method of claim 27 in which the user interface includes a graphic or icon, and the size of shape of one part or section of the graphic or icon relative to a different part or section of the graphic or icon represents the overall healthy building score.

34. The method of claim 27 in which the user interface includes a circle, with the length of an arc in the circle representing the strength of the overall healthy building score.

35. The method of claim 27 in which the user interface includes a graphic representation of the time-based trend of the overall healthy building score.

36. (canceled)

37. The method of claim 27 in which the user interface includes an option that when selected shows the overall healthy building scores of other buildings or environments.

38. (canceled)

39. (canceled)

40. (canceled)

41. The method of claim 27 in which the user interface displays a desk occupancy heatmap that graphically represents the level of desk occupancy as a function of day of the week and time.

42. The method of claim 27 in which the user interface displays an automatically generated description of one or more predicted issues or problems associated with environmental performance scores that exceed thresholds.

43. (canceled)

44. (canceled)

45. The method of claim 1 in which the environmental performance parameters measured by the sensor or sensors are processed by a computer system configured to process different types of environmental performance parameters to automatically identify correlations or linkages between different types of environmental performance parameters and then automatically generating actions and/or recommendations based on the correlations or linkages, and displaying the actions and/or recommendations on a user interface.

46. The method of claim 1 in which the environmental performance parameters measured by the sensor or sensors are processed by a computer system configured to generate actions and/or recommendation based on combining different types of environmental performance parameters.

47. The method of claim 46 in which the computer system is configured to combine the environmental performance parameters of temperature data from water pipe temperature sensors, analysed for legionella compliance, with the environmental performance parameter of room usage.

48. The method of claim 46 in which the computer system is configured to combine the environmental performance parameters of temperature data from water pipe temperature sensors, analysed for legionella compliance, with the healthy building score.

49. The method of claim 46 in which the computer system is configured to combine the environmental performance parameters of temperature data from water pipe temperature sensors, analysed for legionella compliance, with the healthy building score and to automatically display predicted issues relating to potential legionella noncompliance.

50. (canceled)

51. A system for monitoring a building, the system including:
(a) a network of sensors in the building to measure multiple different environmental performance parameters, in which a sensor in the network measures a specific environmental performance parameter;
(b) a computer implemented AI (e.g. deep learning) system running on a computer and that has been trained to predict or infer a different environmental performance parameter, based on the specific environmental performance parameter;
(c) a computer configured to automatically process that different environmental performance parameter, as well as environmental performance parameters from other sensors, using a scoring algorithm running on a processor, to generate an overall healthy building score.

52. The method of claim 1, in which the computer implemented AI system is a deep learning system using a neural network that is effective for modelling time series sequence data.

53. The method of claim 52, in which the deep learning system has been trained on control data derived from using a proximity sensor to detect the presence of a person, as well as the temperature sensor and/or on control data derived from using a water flow sensor to detect the flow of water from opening an outlet to the water pipe, as well as the temperature sensor.
